(19) United States
(12) Patent Application Publication
(10) Pub. No.: US 2026/0330346 A1
(43) Pub. Date: Oct. 22, 2026

(54) DETECTING AND PROCESSING INCONSISTENT SCHEDULING DATA

(71) Applicant: Microsoft Technology Licensing, LLC, Redmond, WA (US)

(72) Inventors: David Shigeru TANIGUCHI, Kirkland, WA (US); Hung-chih YANG, Redmond, WA (US); Chenlei FANG, Bellevue, WA (US); Stephanie Rosenthal POMERANTZ, Pittsburgh, PA (US); Atulya RAVISHANKAR, Redmond, WA (US); Ning GAO, Kirkland, WA (US); Christopher Patrick MUIR, Boston, MA (US); Zachary Ben RUBINSTEIN, Allison Park, PA (US); Ronit BOHRER HILLEL, Redmond, WA (US)

(21) Appl. No.: 19/216,879

(22) Filed: May 23, 2025

Related U.S. Application Data
(60) Provisional application No. 63/789,576, filed on Apr. 16, 2025.

(51) Int. Cl. G06Q 10/0631; G06Q 10/02

(52) U.S. Cl. CPC G06Q 10/06311; G06Q 10/02

(57) ABSTRACT

Some embodiments detect infeasible scheduling requests, such as overlapping do-not-move bookings with a given resource required at different locations, bookings with insufficient travel time, or other enumerated examples. Some embodiments utilize retrieval augmented generation or language model function invocation or both to summarize infeasibility patterns, or to explain scheduling decisions, or to do both. Some embodiments utilize virtual bookings to produce a partial schedule instead of declining to produce any schedule which involves conflicts. Some embodiments partition a scheduling problem into smaller problems using an eligibility graph, or using clusters computed from location data and shift assignment exploration, or both.

### BACKGROUND

Technical fields such as artificial intelligence and operations research utilize constraint satisfaction technology to help solve problems that involve a set of constraints for particular variables to satisfy. Some of the techniques and tools used by constraint satisfaction technology implemented in computing systems include constraint logic programming, backtracking search, constraint propagation, local search, a simplex algorithm for solving linear or polynomial equations or inequalities, and constraint satisfaction toolkits which are computationally accessed by software in C, C++, Comet, Java, Lisp, Prolog, Python, and other programming languages.

In general, constraint satisfaction is complex and therefore difficult to perform computationally. Solving a constraint satisfaction problem on a finite domain is an NP-complete problem with respect to the size of the domain. A NP-complete problem is a problem for which no polynomial-time solution is known. In addition to constraint satisfaction, some other examples of NP-complete problems include graph-covering problems and the traveling salesperson problem. The traveling salesperson problem is how to visit each city on a given list of cities exactly once and return back to the starting city, while following the shortest possible route.

In some situations, an administrative change can avoid the difficulty of solving a given constraint satisfaction problem by abandoning the original problem and solving a simpler problem instead. For instance, a given traveling salesperson problem is replaced by a simpler problem when an administrative change removes one or more cities from the list, so the traveling salesperson is no longer required to visit all the cities on the original list.

But administrative changes are not always available, and not always acceptable. Thus, technology improvements that make constraint satisfaction more computationally efficient would be beneficial.

### SUMMARY

Some embodiments address technical challenges arising in job scheduling. One challenge is how to improve the efficiency of job scheduling, and expand the set of scheduling requests which produce at least a partial schedule, by technical improvements as opposed to mere administrative changes. Another challenge is how to process inconsistent data in scheduling requests. Another challenge is how to facilitate user input of consistent data in scheduling requests. Other technical challenges are also addressed herein.

Some embodiments taught herein provide or utilize job scheduling technology which computationally does at least one of (a) in scheduling request data, identifies bookings which overlap or lack sufficient travel time; groups the identified bookings into a virtual booking; and computes a schedule using the virtual booking; (b) in scheduling request data, recognizes an infeasibility which involves work attributes; processes the infeasibility using attribute matching and an eligibility graph; (c) in scheduling data, recognizes an infeasibility which involves temporal rules that describe relationships between work on a resource's schedule; processes the infeasibility using temporal adaptation; (d) summarizes scheduling infeasibility patterns, and responds helpfully to queries about a schedule; or (e) reduces computational resource usage, promotes scaling, and speeds up processing by dividing a scheduling request into smaller problems by location-based partitioning. Other job scheduling refinements and variations are also taught herein.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems and also illustrating configured storage media, including some aspects generally suitable for embodiments which include or use detection and processing of inconsistent scheduling data (DPISD) functionality, which in some but not all scenarios includes or uses job scheduling with efficiency filters (JSEF) functionality;

FIG. 2 is a block diagram illustrating aspects of a family of enhanced systems which are each configured with JSEF functionality;

FIG. 3 is a block diagram illustrating some aspects of jobs and associated data structure or other computational representations of jobs;

FIG. 4 is a block diagram illustrating some aspects and examples of job filters in a computing system;

FIG. 5 is a block diagram illustrating aspects of some resources which can be scheduled to perform jobs;

FIG. 6 is a block diagram illustrating some aspects of job scheduling in a computing system;

FIG. 7 is a flowchart further illustrating some JSEF methods;

FIG. 8 is a flowchart further illustrating JSEF and DPISD methods, and incorporating as options the steps of FIG. 7, the steps of FIGS. 9-13, and other steps discussed herein;

FIG. 9 is a flowchart further illustrating some JSEF methods;

FIGS. 10 through 13 are respective flowcharts, each further illustrating some DPISD methods;

FIG. 14 is a bookings diagram illustrating aspects of some temporal adaptations, one or more of which are performed by some DPISD methods;

FIGS. 15 through 18, 20, and 21 are respective bookings diagrams illustrating aspects of some overlaps, including overlaps which are detected by some DPISD methods;

FIG. 19 is a data flow diagram illustrating an architecture which includes a partitioner, a temporal edge case handler, and other components, which upon execution perform one or more DPISD methods;

FIG. 22 is an eligibility graph diagram illustrating aspects of eligibility graph partitioning, which is performed by some DPISD methods;

FIG. 23 is a bookings diagrams illustrating aspects of insufficient travel time, including insufficiencies which are detected by some DPISD methods;

FIGS. 24 through 27 are respective bookings diagrams illustrating aspects of some intersections of an optimization range with one or more shifts, including intersections which are detected by some DPISD methods;

FIG. 28 is a bookings diagram illustrating aspects of some locked (a.k.a. do-not-move) bookings or insufficient travel time conditions, including conditions which are detected by some DPISD methods; and

FIG. 29 is a bookings diagram illustrating aspects of some insufficient travel time conditions, including conditions which are detected by some DPISD methods.

### DETAILED DESCRIPTION

### Overview

Some teachings described herein were motivated by technical challenges faced and insights gained during efforts to improve job scheduling software. These challenges and insights provided some motivations, but the teachings herein are not limited in their scope or applicability to these particular tools, motivational challenges, solutions, or insights.

In some scenarios, a field technician, plumber, maintenance engineer, or other human service provider has jobs to be done at various job locations. This raises the problem of trying to determine an optimal route for the service provider to travel to the jobs. Some software tools accordingly attempt to generate an optimal job schedule, e.g., first travel to a location L7 and do a job J14, then travel to a location L3 and do a job J5, then travel to a location L12 and do a job J44, and so on. In this example and elsewhere herein, numbers in identifiers are meant merely to distinguish items, not to necessarily indicate an order of job performance, or a spatial relationship, or a priority, a category, etc. The job schedule's route reflects an effort to be optimal according to some measure, e.g., least time spent traveling, largest number of jobs completed, etc.

As inputs, a job scheduling software tool sometimes has data such as the set of possible jobs for the service provider to complete, job priorities and other preferences representing the importance of completing various jobs, promised time windows for the service provider to arrive at the jobs (e.g., a customer is only available in the mornings), a working time window for the service provider, the service provider's own starting and ending location(s), and so on.

But even with such constraint data, the job scheduling software often faces a challenge based on a combinatorial explosion. The computational complexity of scheduling grows rapidly as jobs are added to the list of jobs to be scheduled.

In one example scenario, there are 50 possible jobs, but only 5 jobs will fit into a workday. The number of possible combinations of 5 jobs chosen from 50 jobs is (50!/(45!*5!)), which is more than two million (2118760). The exclamation sign! represents a factorial operation. N! equals the product of all numbers from 1 through N, e.g., 5!=5*4*3*2*1. Moreover, these are the combinations, not the permutations-combinations do not specify an order, whereas permutations do specify order. The number of possible permutations of 5 jobs chosen from 50 jobs is (50!/(50−5)!), which equals 50*49*48*47*46, which is more than 254 million (254251200). An algorithm to find an optimal selection of 5 jobs from the set of 50 jobs, and an optimal ordering of those 5 jobs (i.e., an optimal permutation), by comparing each possibility to every other possibility, would therefore take a very long time to run. However, seeking some amount of schedule optimization is often worth some computational cost, in order to make the service provider's services more efficient.

An administrative action could reduce the number of possibilities, and thereby reduce the computational costs of scheduling, by striking jobs from the list of possible jobs to be scheduled. This administrative action could be taken by a service provider's manager, for instance, in response to business or legal considerations such as overdue customer accounts, an upcoming vacation, or a regulation limiting the number of unscheduled jobs carried on the books for more than two weeks. Suppose 30 jobs are stricken from the list by the manager for these or other non-technical (administrative) reasons, leaving only 20 jobs to be scheduled instead of 50 jobs. Then the total number of permutations would be reduced from over 254 million to (20!/(20−5)!)=20*19*18*17*16, which is less than 2 million (1860480).

But what about situations in which jobs are not simply stricken by an administrator from the list of jobs to be scheduled? Instead of administrative approaches to reducing computational cost, the present disclosure focuses on situations in which computational efficiency is gained by improvements in the scheduling technology. When an embodiment does remove a job from a list, the removal is arrived at by technical considerations, not as an administrative action. For example, some embodiments detect inconsistent data within job scheduling requests, and separate them into virtual bookings which are marked as unschedulable. This reduces the use of computational resources on unsolvable problems, and speeds processing. Some embodiments use location-based partitioning to divide scheduling problems into smaller subproblems, which likewise reduces computational resource usage, speeds processing, and also promotes scalability.

Some embodiments described herein utilize or provide a job scheduling method which is performed by a computing system, in particular but not only as discussed in connection which some “nuggets” of DPISD functionality that are enumerated and illustrated below. In a given embodiment, the DPISD functionality enables 1330 one or more technical benefits 1332 such as: efficiency (avoiding waste of computational resources by not submitting infeasible requests to a scheduler), speed (partitioning a scheduling problem into smaller subproblems which are collectively solved faster, and may be parallelizable to facilitate load balancing and scalability), smaller storage and less bandwidth (via partitioning), effectiveness (providing at least partial schedules via use of virtual bookings, instead of simply refusing a scheduling request that contains inconsistent data), and improved usability which overcomes a particular vulnerability or failure of other approaches by early detection of infeasibilities due to inconsistent scheduling request data, summarization of such infeasibilities to identify patterns, and interactive language model querying to enhance the explainability of scheduling decisions.

Some embodiments include or utilize an infeasibility detection mechanism which upon execution detects at least one of: a worker present in two overlapping do-not-move bookings at two different job locations; a conflict which involves overlapping shifts or overlapping breaks or both; a booking overlapping with a shift depot; overlapping bookings within a shift; overlapping bookings overlapping with a shift depot; overlapping bookings with multiple shifts; or overlapping bookings exceed a shift. This DPISD functionality has the technical benefit of avoiding waste of computational resources by not submitting detected infeasible requests to a scheduler. In some cases, these inconsistencies are packed into virtual bookings which the enhanced system then schedules around, thereby providing the technical benefit of producing at least partial schedules instead of simply refusing a scheduling request that contains inconsistent data from a customer.

Some embodiments include or utilize a virtual booking mechanism which upon execution creates at least one of: a virtual booking which corresponds to an on-site booking which overlaps a shift; a virtual booking which corresponds to location-agnostic booking or a break which overlaps a shift; a virtual booking which encapsulates overlapping do-not-move bookings; or a virtual booking which groups overlapping bookings. This DPISD functionality has the technical benefit of avoiding waste of computational resources by not submitting infeasible virtual booking requests to a scheduler. This also has the technical benefit of producing at least partial schedules in which some or all of the bookings outside the virtual booking are scheduled, instead of simply refusing any scheduling request that contains inconsistent data from a customer.

Some embodiments include or utilize a schedule investigation mechanism which upon execution performs at least one of: execution of an interactive language model feature which processes an inquiry about a scheduling decision, provides an explanation of a reasoning behind the scheduling decision, and highlights a conflict constraint or a data inconsistency that influenced the scheduling decision; execution of an interactive language model feature which utilizes chunking and retrieval augmented generation and provides an explanation of a scheduling decision that involves inconsistent customer-provided data; or execution of an interactive language model feature which utilizes language model function calls and provides an explanation of a scheduling decision that involves inconsistent customer-provided data. This DPISD functionality has the technical benefit of enhancing the explainability of scheduling decisions, and facilitating user input of scheduling requests which are valid and consistent.

These and other benefits will be apparent to one of skill from the teachings provided herein.

### Operating Environments

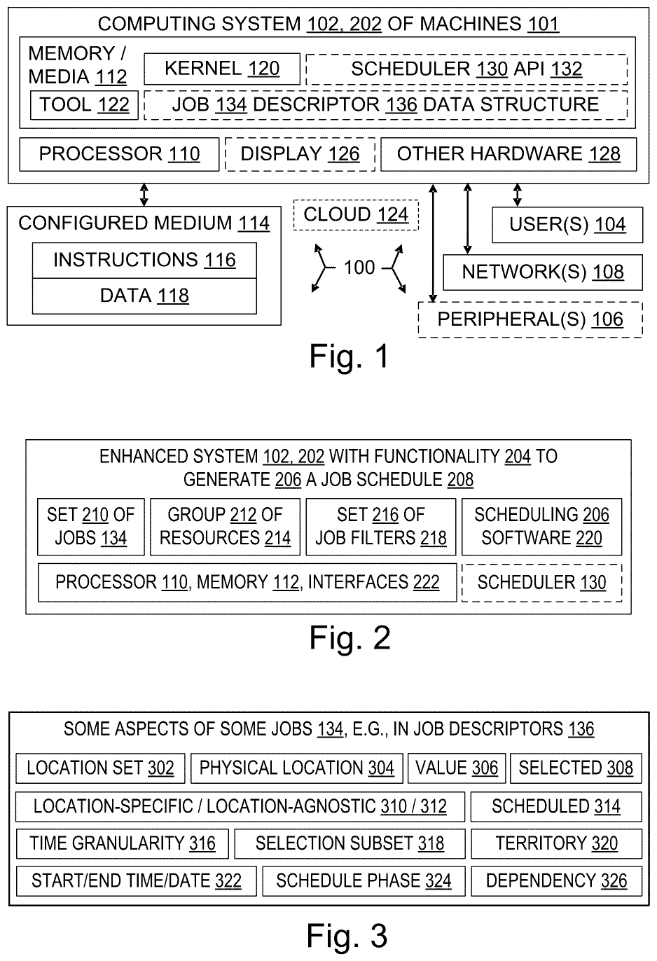

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 124. An individual machine is a computer system, and a network or other non-empty group of cooperating machines is also a computer system. A given computer system 102 may be configured for end-users, e.g., with applications, for administrators, as a server, as a distributed processing node, and/or in other ways.

Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

System administrators, network administrators, cloud administrators, security analysts and other security personnel, operations personnel, developers, testers, engineers, auditors, and end-users are each a particular type of human user 104. In some embodiments, automated agents, scripts, playback software, devices, and the like running or otherwise serving on behalf of one or more humans also have user accounts, e.g., service accounts. Sometimes a user account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

The distinction between human-driven accounts and machine-driven accounts is a different distinction than the distinction between attacker-driven accounts and non-attacker driven accounts. A particular human-driven account may be attacker-driven, or non-attacker-driven, at a given point in time. Similarly, a particular machine-driven account may be attacker-driven, or non-attacker-driven, at a given point in time.

Although for convenience, examples and claims herein sometimes speak in terms of accounts, “account” means “account or session or both” unless stated otherwise. In this disclosure, including in the claims and elsewhere, a statement about activity by “the user account or the user session” does not mean that both the user account and the user session must be present. Instead, such a statement is to be understood as a pair of corresponding but distinct statements given as alternatives, one statement being about activity by the user account, and the other statement being about activity by the user session. Likewise, a characterization of “the user account or the user session” does not mean that both the user account and the user session must be present. Instead, such a characterization is to be understood as a pair of corresponding but distinct characterizations given as alternatives, one characterizing the user account, and the other characterizing the user session.

Storage devices or networking devices or both are considered peripheral equipment in some embodiments and part of a system 102 in other embodiments, depending on their detachability from the processor 110. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS, for example. Files, APIs, endpoints, and other resources may be accessed by an account or non-empty set of accounts, user or non-empty group of users, IP address or non-empty group of IP addresses, or other entity. Access attempts may present passwords, digital certificates, tokens or other types of authentication credentials.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment (JSEF or DPISD or both) is described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments (JSEF or DPISD or both), the system includes multiple computers connected by a wired and/or wireless network 108. Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments, one or more computers are partially or fully “air gapped” by reason of being disconnected or only intermittently connected to another networked device or remote cloud. In particular, functionality 204 (JSEF or DPISD or both) could be installed on an air gapped network 108 which is then updated periodically or on occasion using removable media 114, or not updated at all, depending on particular circumstances. Some embodiments also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some embodiments (JSEF or DPISD or both). This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments (JSEF or DPISD or both) as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, devices, data structures, kinds of data, settings, parameters, components, computational resources, programming languages, tools, workflows, or algorithm implementations, or other items in a computing environment, which are disclosed herein but not associated with a particular reference numeral herein. Corresponding drawings may also be added.

### More About Systems

FIG. 2 illustrates a computing system 102 configured by one or more of the JSEF functionality enhancements taught herein, resulting in an enhanced system 202. In some embodiments (JSEF or DPISD or both), this enhanced system 202 includes a single machine, a local network of machines, machines in a particular building, machines used by a particular entity, machines in a particular datacenter, machines in a particular cloud, or another computing environment 100 that is suitably enhanced as taught herein. FIG. 2 items are discussed at various points herein.

FIG. 3 shows some aspects of some jobs 134 as represented in some enhanced computing systems 202 (JSEF or DPISD or both), e.g., as job descriptor data structures 136.

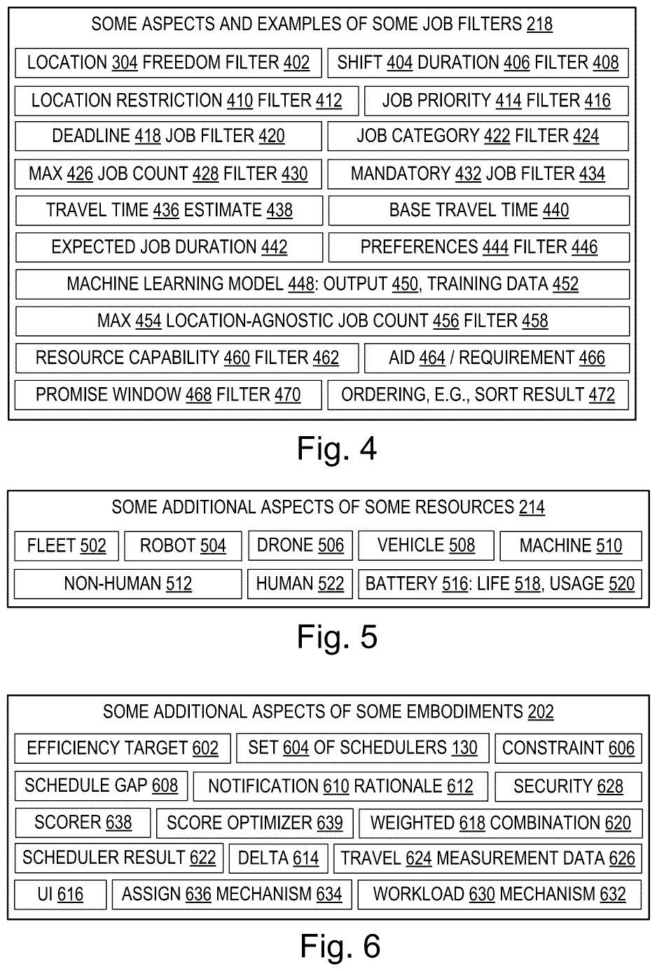

FIG. 4 shows some aspects and examples of some job filters 218 in some enhanced computing systems 202 (JSEF or DPISD or both).

FIG. 5 shows some aspects and examples of some job performing resources 214 (JSEF or DPISD or both), which are also referred to herein as service providers 214. Non-human resources 214 are part of some enhanced computing systems 202, e.g., robots 504, drones 506, vehicles 508, and other machines 510 (which may sometimes include computers 101). Human resources 214 are external to, but interact with, some enhanced computing systems 202, or respond to schedules from some enhanced computing systems 202. Some resources 214 are tied to a particular physical location 304, e.g., an operating room, a manufacturing facility, a laboratory, etc.

FIG. 6 shows some additional aspects of some embodiments of functionality 204 (JSEF or DPISD or both). Items shown in the figures are discussed at various points herein.

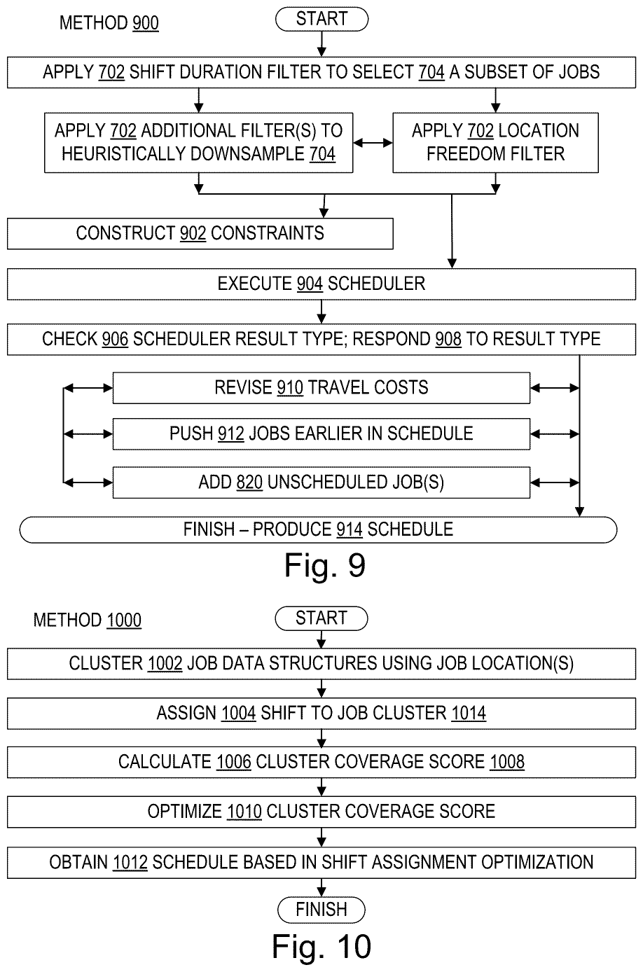

Like FIG. 2, FIGS. 3 through 6 are neither individually nor collectively a comprehensive summary of all aspects of enhanced systems 202 or all aspects of functionality 204 (JSEF or DPISD or both). Nor is any figure or group of figures within FIGS. 1 through 29 a comprehensive summary of all aspects of an environment 100 or system 202 or other context of an enhanced system 202, or a comprehensive summary of any aspect of functionality 204 for potential use in or with a system 102.

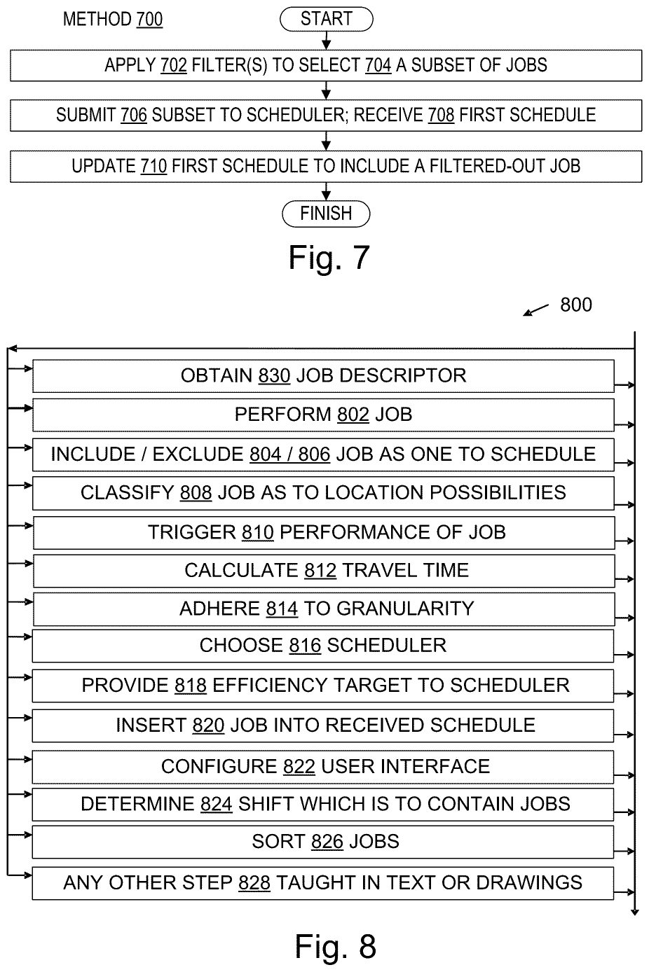

The other figures are also relevant to systems 202. FIGS. 7 through 13 are flowcharts which illustrate some methods of functionality 204 operation in some systems 202 (JSEF or DPISD or both). Other figures within FIGS. 1 through 29 also illustrate data flow, or data conditions which are detected by functionality 204 in operation, or computational results of functionality 204 operation.

In some embodiments (JSEF or DPISD or both), the enhanced system 202 is networked through an interface 222. In some, an interface 222 includes hardware such as network interface cards, software such as network stacks, APIs, or sockets, combination items such as network connections, or a combination thereof.

Some embodiments (JSEF or DPISD or both) include a computing system 202 which is configured to utilize or provide functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101, but “memory” without set also includes systems with multiple memories. Similarly, the phrase “processor set” is used to emphasize that a processor 110 is not necessarily confined to a single chip or a single machine 101, but “processor” without set also includes systems with multiple processors.

All sets herein are non-empty unless described otherwise.

In this example, a computing system 202 (JSEF or DPISD or both) configured for job scheduling includes at least one processor 110, which is in operable communication with at least one digital memory; the at least one digital memory includes volatile storage and non-volatile storage unless indicated otherwise.

The digital memory in this example contains one or more data structures 136 which correspond to a nonempty set 210 of jobs 134. Each job of the set has a resource group 212 identifying at least one resource 214 which has a capability 460 to perform at least a portion of the job, consistent in some embodiments with a resource capability filter 462. Each job of the set has an expected job duration 442. In some scenarios, each job of the set is classified as either location-agnostic 312 or location-specific 310, with each location-specific job specifying a physical location 304, and at least one job of the set being classified as location-agnostic.

In some scenarios, the computing system 202 (JSEF or DPISD or both) also includes a nonempty set 216 of job filters 218 which are each executable by the computing system. Some embodiments specify an aid 464 for scheduling, which is influential but not a requirement 466.

The at least one processor 110 is configured to perform a job scheduling method 800. This method 800 includes (a) forming a nonempty subset 318 of selected jobs 308, 134 by selecting 704 multiple jobs from the set of jobs, the selecting including excluding 806 from the subset at least one job by applying 702 at least one of the job filters 218, (b) submitting 706 the subset of selected jobs to a scheduler 130 via an application program interface 132, (c) receiving 708 from the scheduler via the application program interface a first phase schedule 208 which specifies scheduled 314 jobs, and (d) producing a second phase schedule 208 at least by updating 710 the first phase schedule to include 804 at least one job which was excluded 806 by applying at least one of the job filters.

Here, as elsewhere herein, labels such as (a), (b), etc. in a method description are meant to aid legibility of the description (JSEF or DPISD or both), not to impose a strict order or a total ordering of actions in the method. For instance, steps labeled as (a), (b), etc. for convenience may overlap in some embodiments, or interleave.

In some embodiments (JSEF or DPISD or both), the set 216 of job filters includes at least one of: a location freedom filter 402 which is configured to computationally filter in location-specific 310 jobs or to computationally filter out location-agnostic 312 jobs, or to do both; a shift duration filter 408 which is configured to computationally filter in jobs for which the expected job duration 442 plus a travel time estimate 438 does not exceed a shift 404 duration 406, or to computationally filter out jobs for which the expected job duration plus a travel time estimate does exceed a shift duration, or to do both; a mandatory job filter 434 which is configured to computationally filter in jobs which are mandatory 432 or to computationally filter out jobs which are not mandatory, or to do both; or a deadline job filter 420 which is configured to computationally filter in jobs which have a deadline 418 or to computationally filter out jobs which do not have a deadline, or to do both.

In some embodiments (JSEF or DPISD or both), the computing system 202 is configured to schedule 206 a fleet 502 of resources 214 to collectively perform at least a majority of the set 210 of jobs 134, or to perform at least a specified percentage of the set 210, or at least a specified number of jobs of the set 210. In some embodiments (JSEF or DPISD or both), the computing system 202 is configured to proactively trigger 810 at least one resource 214 to perform 802 at least one job 134 according to the second phase schedule 208. In some embodiments (JSEF or DPISD or both), the digital resource group 212 identifies as one or more resources 214 at least one of: a physical robot 504; a physical drone 506; a self-driving vehicle 508; a physical machine 510; or a non-human 512 physical resource 214. Humans 522 are not part of an embodiment, but data 118 representing humans 522 can be part of an embodiment.

Some embodiments include a computing system 202 configured for job scheduling using location-based partitioning, the computing system including: a digital memory 112 containing job data structures 136, each job data structure identifying at least one resource 214 which has a capability to perform at least a portion of a corresponding job 134, a job duration 442, and a job location 304 which either specifies a physical location 310, 304 of the job or specifies that the job is location-agnostic 312, 304 (location-agnostic is also shown in the figures as LA); a processor 110 in operable communication with the digital memory and configured by executable processor instructions 116; a clustering mechanism 1002 which upon execution provides job data structure clusters 1014 computed from at least the job locations; a shift calculation mechanism 632 which upon execution calculates a cluster workload 630 and a number of shifts corresponding to the cluster workload; a shift assignment mechanism 634 which upon execution provides an assignment 636 that assigns a particular shift to a particular job cluster; a cluster coverage score calculation mechanism 638 which upon execution calculates a cluster coverage score 1008; a cluster coverage score optimization mechanism 639 which upon execution optimizes at least one cluster coverage score by utilizing at least one shift assignment change; and a job scheduling mechanism 220 which upon execution by the computing system provides 708 a schedule 208 of at least a subset of the jobs, the schedule computed from at least one shift assignment 636 or at least one shift assignment change 636 or both.

Some embodiments include an infeasibility 1122 detection mechanism 1104 which upon execution 1104 detects at least one of: a worker present in two overlapping do-not-move 2204 bookings 1320 at two different job locations; a conflict 1122 which involves overlapping shifts 404 or overlapping breaks 1502 or both; a booking overlapping with a shift depot 1702; overlapping bookings within a shift; overlapping bookings overlapping with a shift depot; overlapping bookings with multiple shifts; or overlapping bookings exceed a shift.

Some embodiments include an infeasibility 1122 detection mechanism 1104 which upon execution 1104 detects at least one of: do-not-move bookings with insufficient time 436; or insufficient travel time between jobs.

Some embodiments include an infeasibility 1122 summarization mechanism 1202 which upon execution generates a summary of at least one pattern 1204 of detected infeasibilities.

Some embodiments include a virtual booking mechanism 1118 which upon execution creates 1116 at least one of: a virtual booking 1118 which corresponds to an on-site booking which overlaps a shift; a virtual booking which corresponds to location-agnostic booking or a break which overlaps a shift; a virtual booking which encapsulates overlapping do-not-move bookings; or a virtual booking which groups overlapping bookings. Overlaps a shift includes overlaps a shift boundary or a shift depot, or both.

Some embodiments include a schedule investigation mechanism 1200 which upon execution performs at least one of: execution of an interactive language model 448 feature which processes an inquiry about a scheduling decision, provides an explanation 1322 of a reasoning behind the scheduling decision 1324, and highlights a conflict constraint or a data inconsistency that influenced the scheduling decision; execution of an interactive language model 448 feature which utilizes 1302 chunking 1304 and retrieval augmented generation (RAG 1306 in the figures) and provides an explanation 1322 of a scheduling decision 1324 that involves inconsistent customer-provided data 1122; or execution of an interactive language model 448 feature which utilizes language model function calls 1310 and provides an explanation 1322 of a scheduling decision 1324 that involves inconsistent customer-provided data 1122.

Other system embodiments (JSEF or DPISD or both) are also described herein, either directly or derivable as system versions of described processes or configured media, duly informed by the extensive discussion herein of computing hardware.

Although specific architecture examples (JSEF or DPISD or both) are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments (JSEF or DPISD or both). A given embodiment may include additional or different kinds of functionality, for example, as well as different technical features, aspects, interfaces, mechanisms, software, expressions, operational sequences, commands, data structures, programming environments, execution environments, environment or system characteristics, agents, proxies, or other functionality consistent with teachings provided herein, and may otherwise depart from the particular examples provided.

Processes (a.k.a. Methods)

Processes (which are also referred to as “methods” in the legal sense of that word) are illustrated in various ways herein, both in text and in drawing figures. FIGS. 7 to 13 each illustrate a family of methods 700, 800, 900, 1000, 1100, 1200, and 1300 respectively, which are performed or assisted by some enhanced systems, such as some systems 202 or another functionality enhanced system as taught herein. Method families other than 800 are each a proper subset of method family 800. Moreover, activities are identified in FIGS. 1 to 29 as explicit or implicit method steps, and are likewise incorporated into method 800, e.g., starting 322 a job, scheduling 206 jobs a.k.a. generating 206 a job schedule, categorizing 422 a job, training 452 a machine learning model, traveling 624 to or from a job, measuring travel time 436, marking 1326 a item as unschedulable 1328 (indicated in the figures by a circle with a diagonal line segment), updating booking data structures 1320 as indicated by update arrows in the figures, determining whether a break 1502 is in progress at a given point in time, determining whether a booking is in progress at a given point in time, and so on. Also, steps that are not expressly tied to a particular reference number are not thereby excluded from method 800. These flowcharts and other diagrams are examples; as noted elsewhere, any operable combination of steps that are disclosed herein may be part of a given embodiment when called out in a claim.

Technical processes shown in the Figures or otherwise disclosed (JSEF or DPISD or both) will be performed automatically, e.g., by an enhanced system 202, unless otherwise indicated. Related non-claimed processes may also be performed in part automatically and in part manually to the extent action by a human person is implicated, e.g., in some situations a human 104 types or speaks an input such as a particular name for a certain schedule 208 to be saved under in a computer memory 112, e.g., a filename. Such input is captured in the system 202 as digital text, or captured as digital audio which is then converted to digital text. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment (JSEF or DPISD or both) zero or more illustrated steps of a process may be repeated, perhaps with different parameters or data to operate on. Steps in an embodiment may also be done in a different order than the top-to-bottom order that is laid out in FIG. 8 or other Figures.

FIG. 8 and similar figures are each a portion of the textual and figure drawing examples of embodiments provided herein and the descriptions of embodiments provided herein. In the event of any alleged inconsistency, lack of clarity, or excessive breadth due to an interpretation of FIG. 8 or other Figures, the content of this disclosure shall prevail over that interpretation of FIG. 8 or other Figures.

Arrows in process or data flow figures (JSEF or DPISD or both) indicate allowable flows; arrows pointing in more than one direction thus indicate that flow may proceed in more than one direction. Steps may be performed serially, in a partially overlapping manner, or fully in parallel within a given flow. In particular, the order in which flowchart 800 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 8 or another figure to be non-operable, the sequence S is not within the scope of any claim. Any assertion otherwise is contrary to the present disclosure.

Some embodiments provide or utilize a scheduling method 800 in a computing system 102, e.g., in a computer network 108. This method 800 includes automatically: obtaining 830, in the memory, one or more job descriptor data structures 136 which correspond to a nonempty set 210 of jobs 134, each job of the set having an expected job duration 442; classifying 808 multiple jobs of the set as respectively either location-agnostic 312 or location-specific 310, each location-specific job specifying a physical location 304, the classifying including classifying at least one job of the set as location-agnostic; forming a nonempty subset of selected jobs by selecting 704 multiple jobs of the set, the selecting including applying 702 a location freedom filter 402 which is configured to computationally filter in location-specific jobs or to computationally filter out location-agnostic jobs or to do both, the applying including 804 in the subset at least one location-specific job of the set and excluding 806 from the subset at least one location-agnostic job of the set; submitting 706 the subset of selected jobs to a scheduler 130 via an application program interface 132; receiving 708 from the scheduler via the application program interface a first phase 324 schedule 208 which specifies scheduled jobs; and producing 914 a second phase 324 schedule 208 at least by updating 710 the first phase schedule to include at least one location-agnostic job which was excluded by applying the location freedom filter.

In some embodiments, updating 710 the first phase schedule includes the computing system: applying 702 a location restriction filter 412 to a particular location-agnostic job, thereby restricting the particular location-agnostic job to a nonempty proper subset 302 of physical locations 304 which have scheduled jobs in the first phase schedule; submitting 706 the first phase schedule 208, the particular location-agnostic 312 job 134 (e.g., as a data structure 136), and the subset 302 of physical locations (as data 118 which identifies the locations 304) to the scheduler via the application program interface; and receiving 708 the second phase schedule from the scheduler via the application program interface. A proper subset of a larger set of locations is itself a set of locations.

Some embodiments attempt to reduce the number of combinations that are generated in pursuit of a schedule. Any location-agnostic job could take place at every possible location 304 unless the possible locations are restricted. Some embodiments therefore enforce a rule that location-agnostic jobs can only be done at the location 304 of one of their neighboring location-specific jobs (the job scheduled before the location-agnostic job or the job schedule after it). This reduces the number of locations substantially, thereby reducing computational load on the scheduler 130 in exchange for the loss of flexibility in scheduling the location-agnostic job.

In some scenarios, some embodiments schedule a location-agnostic job to occur during a location-specific job, when the resource(s) assigned to the location-specific job have sufficient capacity to also perform the location-agnostic job. In some embodiments, selecting 704 multiple jobs includes the computing system performing at least one of: applying 702 a maximum 454 job count 456 filter 430 or 458 which constrains the subset to include at most a maximum 426 number 428 of jobs or LA jobs; applying 702 a job categories filter 424 which constrains the subset according to an ordering 472 of job categories 422; or applying 702 a job priorities filter 416 which constrains the subset according to job priorities 414.

In some embodiments, the method 800 includes the computing system: calculating 812 a base travel time 440 for a location-specific job, wherein the base travel time is calculated as a minimum of estimated travel times 438 to the location-specific job from other location-specific jobs in the set of jobs; setting 812 the base travel time to zero for a location-agnostic job; determining 824 a shift 404 which has a start time 322 and an end time 322, the shift having a shift duration 406 which is greater than zero; and applying 702 a shift duration filter 408 to at least a portion of the set 210 of jobs prior to submitting the subset of selected jobs to the scheduler, wherein applying the shift duration filter includes removing 806 from the set of jobs a job for which the expected job duration plus the base travel time is greater than the shift duration.

In some embodiments, the method 800 includes the computing system: calculating 812 a base travel time 440 for a location-specific job, wherein the base travel time is calculated as a minimum of estimated travel times 438 to the location-specific job from other location-specific jobs in the set of jobs, wherein the location-specific job is in the subset of selected 308 jobs, and wherein the base travel time for the job adhered 814 to a first granularity 316 when the subset of selected jobs was submitted 706 to the scheduler; and producing 914 the second phase schedule at least by revising 910 the base travel time for the location-specific job to adhere 814 to a second granularity 316, the second granularity being finer than the first granularity.

Some embodiments also change the schedule depending on when the optimization window is (the window being scheduled). For example, in one scenario an embodiment plans one job per day when planning a month out, but then as the start date gets closer the embodiment amends the schedule to fit in another small job at the end of the day. Sometimes, the embodiment also adds more buffer time into a day, but if it rescheduled the day of, it sometimes removes more of that buffer time in response to increased scheduling certainty.

In some embodiments, the method 800 includes at least one of: choosing 816 the scheduler from a set 604 of at least two schedulers 130, the choosing computed from at least an efficiency target 602 to choose the scheduler best suited to meeting the efficiency target; or providing 818 an efficiency target 602 to the scheduler via the application program interface 132. In some embodiments, an efficiency target 602 is minimizing a delta (i.e., difference) 614 between different resource characteristics and the required or aid characteristics for the jobs.

In some embodiments, updating 710 the first phase schedule includes inserting 820 the at least one location-agnostic job in at least one of: a gap 608 in the first phase schedule which is not occupied by any scheduled 314 job; a travel time period 624 to a scheduled job; or a travel time period 624 from a scheduled job. In some scenarios, some embodiments schedule a first location-agnostic job next to a second location-agnostic job.

In some embodiments, the method 800 includes configuring 822 a user interface (shown as UI, e.g., in the figures) 616 of the computing system with a notification 610, the notification including at least one of: a rationale 612 for excluding 806 a particular job from at least one of the schedules; or a rationale 612 for including 804 a particular job in at least one of the schedules. For example, some notifications 610 report that a job was filtered because it is infeasible to reach, or because it didn't have a high enough priority to schedule. Some notifications report heuristic results, e.g., a location-agnostic job could not be scheduled next to a location-specific job because heuristic down-sampling filtered out the location-specific job's location. Some embodiments create notifications when jobs are added back, e.g., added into a second phase schedule, based on time or priority or both.

In some embodiments, the method 800 includes determining 824 a shift 404 which has a start time 322 and an end time 322, the shift having a shift duration 406 which is greater than zero, the shift duration computed at least from a battery 516 life 518 of a battery-powered machine 510; and applying 702 a shift duration filter 408 to at least a portion of the set of jobs prior to submitting 706 the subset of selected jobs to the scheduler, wherein applying the shift duration filter includes removing 806 from the set of jobs a job for which the expected job duration 442 plus an estimate of battery usage 520 during travel 624 is greater than the shift duration.

It is expected that job duration 442 will most often be greater than zero, but in some scenarios such as automated package delivery without stopping physical travel, or electronic delivery of data, a job duration equal to zero is used.

In some embodiments, selecting 704 multiple jobs includes the computing system applying 702 a preferences filter 446. In some embodiments, the preferences filter 446 sorts 826 at least a portion of the set of jobs according to an output 450 from a machine learning model 448, the machine learning model trained at least in part on training data 452 which represents customer preferences 444, e.g., indicating which jobs have greater value 306, greater urgency, less risk, and so on. In some embodiments, the preferences filter 446 sorts at least a portion of the set of jobs according to security characteristics 628 and security preferences 444, e.g., favoring on-premise calculations, obtaining additional authentication or authorization to schedule certain jobs, and so on. In some embodiments, the preferences filter 446 sorts at least a portion of the set of jobs according to travel time 440, and in some cases the preferences filter enforces a cutoff to exclude jobs whose travel time is greater than a specific threshold (the threshold is a default, or customer-defined, or user-defined, or machine-learned). Some embodiments perform a secondary sort on job name, job number, or another job identifier, to detect duplicate lists. A combined functionality preferences filter is itself a preferences filter, and a combination of preferences filters which have different respective functionalities by enforcing different preferences, is also itself a preferences filter.

In some embodiments, the computing system performs a method 800, 1000 for job scheduling using location-based partitioning, which includes: clustering 1002 job data structures into clusters computed from at least job locations of job data structures, each job data structure identifying at least one resource which has a capability to perform at least a portion of a corresponding job, a job duration, and a job location which either specifies a physical location of the job or specifies that the job is location-agnostic; assigning 1004 a shift to a particular job cluster; calculating 1006 a cluster coverage score; optimizing 1010 at least one cluster coverage score by utilizing at least one shift assignment change; and obtaining 102 a schedule computed from at least one shift assignment or at least one shift assignment change or both.

In some embodiments, the method 800 includes repairing 1312 overlapping bookings, e.g., overlapping do-not-move bookings, wherein repairing overlapping bookings includes: finding 1314 two bookings which have respective durations that overlap one another; creating 1116 a virtual booking which represents a continuous span of time that includes the two bookings; and during scheduling, preventing 1316 assignment of other jobs to the continuous span of time.

In some embodiments, the method 800 includes repairing 1312 insufficient travel time bookings, wherein repairing insufficient travel time bookings includes: finding 1314 two bookings which lack sufficient travel time between one another; creating 1116 a virtual booking which represents a continuous span of time that includes the two bookings; and during scheduling, preventing 1316 assignment of other jobs to the continuous span of time.

In some embodiments, the method 800 includes: determining 1318 that a shift is covered by a set of one or more do-not-move bookings; and in response to the determining, removing 704 the shift from data selected for submission to a scheduler to obtain the schedule.

In some embodiments, the method 800 includes: determining 1318 that a do-not-move booking fails to overlap any shift; and in response to the determining, marking 1326 the do-not-move booking as unschedulable, instead of e.g., moving 912 it to an earlier time.

In some embodiments, the method 800 includes: determining 1318 that a booking fails to overlap any shift; in response to the determining, marking 1326 the booking as unschedulable; and removing 704 the booking from an eligibility graph 1106.

In some embodiments, the method 800 includes: determining 1318 that a do-not-move booking overlaps at least one shift; and in response to the determining, copying 704 the do-not-move booking into a partition 2202 which includes the at least one shift.

In some embodiments, the method 800 includes: determining 1318 that a booking has an intersection with a shift boundary; and in response to the determining, removing the intersection by truncating 1312 the shift. Some embodiments also mark the booking as unschedulable.

In some embodiments, the method 800 includes at least one of: obtaining 1012 the schedule as a partial solution which includes at least one conflicting do-not-move booking; calculating 1126 a travel time to a virtual booking; calculating 1126 a travel time from a virtual booking; setting 1124 a start location of a virtual booking; or setting 1124 an end location of a virtual booking.

### Configured Storage Media

Some embodiments (JSEF or DPISD or both) include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items such as job scheduling software 220, job descriptor data structures 136, resource group 212 data structures, executable job filters 218, efficiency targets 602 (which are implemented as digital variables or digital values), weighted 618 combinations 620, job priorities 414, job categories 422, times 322, 436, 438, 440, location sets 302, various sets and subsets which are implemented as digital variables or digital values, notifications 610, and scheduler results 622, 208, in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing job scheduling functionality 204 (JSEF or DPISD or both) as disclosed herein. The Figures thus help illustrate configured storage media embodiments and process (a.k.a. method) embodiments, as well as system and process embodiments (JSEF or DPISD or both). In particular, any of the method steps illustrated in FIGS. 1 to 29, or otherwise taught herein, may be used to help configure a storage medium to form a configured storage medium embodiment.

Some embodiments use or provide a computer-readable storage device (a.k.a. medium) 112, 114 configured with data 118 and instructions 116 which upon execution by a processor 110 cause a computing system 202 to perform a job scheduling method 800, the method performed by a computing system. This method 800 includes: clustering 1002 job data structures into clusters computed from at least job locations of job data structures, each job data structure identifying at least one resource which has a capability to perform at least a portion of a corresponding job, a job duration, and a job location; assigning 1004 a shift to a particular job cluster; calculating 1006 a cluster coverage score; optimizing 1010 at least one cluster coverage score by utilizing at least one shift assignment change; and obtaining 1012 a schedule computed from at least one shift assignment or at least one shift assignment change or both.

In some embodiments, the method includes calculating 632 a cluster workload 630 and a number of shifts corresponding to the cluster workload. In some embodiments, the method includes detecting 1104 at least N (N being in the range from one to the number of conditions listed) of: a worker present in two overlapping do-not-move bookings at two different job locations; a conflict which involves overlapping shifts or overlapping breaks or both; a booking overlapping with a shift depot; overlapping bookings within a shift; overlapping bookings overlapping with a shift depot; overlapping bookings with multiple shifts; overlapping bookings exceed a shift; do-not-move bookings with insufficient time; or insufficient travel time between jobs.

In some embodiments, the method includes creating 1116 at least one of: a virtual booking which corresponds to an on-site booking which overlaps a shift; a virtual booking which corresponds to location-agnostic booking or a break which overlaps a shift.

In some embodiments, the method includes creating 1116 at least one of: a virtual booking which encapsulates overlapping do-not-move bookings; or a virtual booking which groups overlapping bookings.

### Additional Observations About Some Embodiments

Additional support for the discussion of functionality 204 (JSEF or DPISD or both) herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, inventive step, or industrial applicability. Any apparent conflict with any other patent disclosure, even from the owner of the present subject matter, has no role in interpreting the claims presented in this patent disclosure. It is in the context of this understanding, which pertains to all parts of the present disclosure, that examples and observations are offered herein.

The present disclosure involves scheduling jobs 134, and in particular provides various ways to improve scheduling efficiency. Some of the jobs have a respective physical location 304, while other jobs are location-agnostic 312. For example, in one scenario a schedule 208 of jobs for a plumber 214 includes location-specific 310 jobs at various building locations, and also includes a location-agnostic 312 job which can be done by phone at any scheduled location 304 or between scheduled locations 304 during travel 624.

A resource 214 performing a job may be a human (e.g., plumber, field technician, surgeon, etc.), or the resource 214 may be nonhuman (e.g., drilling rig 510, imaging device 510, construction equipment 510, etc.).

Any characteristics of jobs referred to herein, e.g., those identified in FIG. 3 or FIG. 4, are understood to be implemented as digital data in job descriptor data structures 136 (JSEF or DPISD or both).

Some embodiments obtain 830 some job descriptions (e.g., via a network, API, file read, or GUI), calculate 812 a base travel time for each job (zero for location-agnostic jobs), determine 824 a shift, check for jobs that are infeasible because they would take too long (apply 702 filter 408), and get (706 and 708) a schedule from a scheduler 130, e.g., a constraint solver 130.

In some embodiments using a constraint solver as scheduler 130, constraints 606 are retrieved or otherwise constructed 902 and submitted to the solver 130, or constraints 606 are embedded within the solver 130, or both. Constraints 606 specify, e.g., that two jobs can't occur at the same time, that jobs are to be spaced far apart enough in time to permit travel between job locations, and that mandatory jobs must be scheduled.

Unless stated otherwise, any given claimed embodiment (JSEF or DPISD or both) does not require a particular kind of scheduler 130. Various schedulers 130 utilize one or more of: constraints 606, an eligibility graph, a job group 212, location clusters, or particular algorithms such as adaptive large neighborhood search.

Unless stated otherwise, e.g., by reference to an efficiency target 602, any given claimed embodiment (JSEF or DPISD or both) does not distinguish between feasible schedules and optimal schedules. However, in some embodiments the solver 130 returns a result type 622, which the embodiment checks 906 and responds 908 to. In the operation of a confidential prototype, a solver returns a value 622 representing one of: Optimal (best possible schedule), Feasible (solver found a solution but can't prove it is the best solution in the allotted amount of time), Infeasible (impossible to satisfy the constraints, for example two mandatory jobs overlap in time and require all the capability of the same resource), or Model Invalid (none of the preceding apply).

Some embodiments (JSEF or DPISD or both) employ other heuristic algorithms in scheduling. Some employ an adaptive large neighborhood search (ALNS), with random search. Some employ a more directed search by looking at a map and travel between locations. Some employ additional runs of a constraint solver that will try more complicated actions that include adding new jobs, deleting existing bookings, rearranging existing bookings, etc. Some do small optimizations with a constraint solver over parts of a schedule. Some run different schedulers, e.g., a constraint solver and a statistical scheduler, and merge the resulting schedules. In addition, some embodiments parallelize any or all of the actions discussed in this disclosure.

### Additional Observations About Partitioning

Partitioning is a process to decompose a big scheduling problem into smaller subproblems. A subproblem has the same components as the original problem, mainly two parts: shifts and demands. Jobs and demands are used interchangeably herein, to indicate unscheduled requirements or scheduled bookings.

Some algorithms perform hard partitioning of scheduling problem. In other words, after partitioning, each subproblem will be independently solved. Shifts in one partition will not see jobs in other partitions at all. Each subproblem has at least one shift and one demand. In some embodiments, this step happens after an eligibility graph check, and before travel distance matrix creation step, as illustrated in FIG. 19. Some embodiments or prototypes or alternate approaches have a component Partitioner 1902, which is executed after pulling data, and before retrieving a distance matrix. That partitioner mainly uses eligibility information. It sometimes fails to partition a large problem. In some scenarios the problem still has over 4000 schedulable items (requirements and bookings) after partitioner. This large problem size is a heavy burden for the Optimizer. Not only because of the resulting long running time, but also or instead because sometimes it causes a memory shortage.

To handle big problem sizes, e.g., 1000 or more schedulable items, an efficient partitioning algorithm is beneficial. In some scenarios, at least two items can benefit from partitioning: travel distance finder 1904 and scheduler 130. The travel distance finder 1904 gets 1112 travel data 1114, 626.

Consider a scheduling problem size with up to 50 shifts and at least 1000 bookings/requirements. For travel distance finder, considering the problem as a whole leads to a transit cost matrix for (50*2+1000) locations (consider different start and end depot locations, and all resources and requirements are onsite). This will result in a matrix with size 1100*1100, which is a significant computational cost, and likely a lower bound on the size of many future requests that will be submitted to fully automated scheduling.

As per scheduler, according to internal experiments, the running time increases non-linearly with the number of requirements. The majority of the runtime is from ALNS, as the translator is very quick, and the experiments used Great Circle Distance for transit cost, which is a local calculation.

For example, the below table is a snippet of internal experiment results. It took ~219 seconds to calculate a scheduling problem with 50 shifts and 1300 requirements. By partitioning the problem into two subproblems, each with 25 shifts and ~700 requirements, the running time will roughly be 2*46=92 seconds, even if the scheduling of subproblems is not done in parallel.

| # Resource | # Shift | # Requirement | # Run time |
|---|---|---|---|
| 5 | 25 | 705 | 46.317 |
| 10 | 50 | 1300 | 219.048 |

The experiment data supports an inference that partitioning a big problem into smaller ones is likely to help reduce scheduler running time as well. This also holds true for fully automated scheduling. Partitioning may even help the final scheduling result. In an internal experiment with some datasets with known optimal value, which used an ALNS based algorithm as the solver, it was found that when the problem size is very big, division is helpful to the final solution, as ALNS has a better chance to find near optimal solutions when the problem is small.

Some approaches mainly use eligibility information to do the partitioning. More specifically, one approach uses a bipartite graph decomposition algorithm. Each job is connected to its eligible shifts in the graph, and the partitioning algorithm aims to decompose the graph into individual connected components, as illustrated in FIG. 22. Each connected component is one partition 2202. With this algorithm, it is guaranteed that after partitioning, for every job, all of its eligible resources will be put in the same partition.

This conservative approach guarantees no loss of potential optimal solution. However, it does not consider geo location info, and tends to produce very big partitions. “Geo” stands for geographic or geographical. For example, if there is one job without any constraint, i.e., it can be done by any resource, then the whole bipartite graph will be connected, and only one partition is produced. Another disadvantage of relying mainly or entirely on eligibility information 1106 to do partitioning 1108 is the risk of producing too many small partitions. For example, if each job is hard locked to one shift, then each partition will only have one shift. The partition count will be equal to the number of shifts.

Some embodiments described herein take a different approach. In some embodiments, a data flow (a.k.a. location-based partitioning algorithm) performs partitioning 1110 in multiple phases:
Phase 1: Hard bipartite partitioning 1108.
After this step, if there is still a large subproblem, the flow continues to phase 2.
Phase 2: For subproblems that are still too big, the embodiment utilizes geo information 304 for further partitioning 1110, while also considering eligibility. Here is an algorithm:
   a. First pre-process Do Not Move (DNM) bookings: put the DNM bookings to the same shift into the same cluster. Assign the shift to the corresponding cluster. If the number of clusters exceeds the maximum count, merge them based on geo proximity.
   b. For the remaining jobs, use clustering 1002 methods (e.g., k-means, HDBSCAN (Hierarchical Density-Based Spatial Clustering of Applications with Noise), Quad-tree, linkage, or other) based on geo location. The remaining jobs also join existing clusters composed of DNM bookings, if they are close enough according to a predetermined threshold. If the number of clusters exceeds the maximum count 454, merge them based on geo proximity.
   c. Calculate 632, 1006 the workload 630 of each cluster, and calculate 1006 the number of shifts 404 required proportional to cluster workload.
The workload will be a combination of: total job duration, travel time inside the cluster, travel time from depot to cluster.

$$Number of shifts assigned to cluster i = ⌊ ( Total shifts ) \cdot ( \frac{workload of cluster i}{Sum of workloads of all cluster} ) ⌋$$

d. Assign 1004 shifts to each job cluster based on depot proximity and the count, e.g., first try assign all shifts to the nearest cluster. If exceeding the count of shifts needed, assign the redundant shifts to second nearest cluster, and so on.
e. Calculate 1006 the coverage score 1008 of each cluster; the coverage is the number of jobs that have at least one eligible shift in the same cluster.
f. Optimize 1010, e.g., randomly select a pair of shifts from different clusters (at least one cluster is not fully covered), swap them and check for improvements in coverage score. First start with shifts with the same depot, then try shifts at different depots. This step will not change the number of shifts assigned to each cluster. Iterate N times, up to a predetermined max N.
g. Try to change job assignments, assign the jobs which are still not covered to other clusters. There are two options here: (1) assign to the closest cluster with eligible shifts, to minimize travel time, or (2) assign to the cluster with eligible shifts, also with smallest workload/shift total duration ratio, a goal is to get balanced clusters.
Phase 3: merge the results from all partitions and output as a single output.

Analysis of the flow 1108, 1110: Phase 1 will bring little eligibility impact to the original problem, as a job and all its eligible shifts will be put into the same partition, unless the shift is too far away to be eligible. Phase 2 potentially reduces the optimality of the result, as some eligible shifts of a job can be put into other partitions. But this is inevitable for any further partitioning beyond phase 1.

Some embodiments provide special treatment of temporal invalid 1122 (a.k.a. temporally invalid 1122, infeasible 1122, conflict 1122, inconsistent 1122) do not move 2204 bookings. In practice, customers sometimes create do not move bookings that are temporal invalid, e.g., completely outside any shift range, partially within a shift, cover multiple shifts, lack enough travel time to depot, etc. These bookings are processed in one prototype by TemporalEdgeCaseHandler 1906, and they are marked 1326 as unschedulable demands, which will be restored at the final stage.

In this example architecture, TemporalEdgeCaseHandler execution happens after travel distance finder 1904. Therefore, when doing partitioning, the scheduling problem still has these invalid bookings. Some embodiments decide which partition(s) to put such bookings (demands) into. One algorithm first ignores these demands in partitioning. If a DNM booking does not overlap with any shift, the algorithm puts it in any partition with a shift from the resource it is assigned to. TemporalEdgeCaseHandler will later correctly mark 1326 it as unschedulable. In some scenarios, if a DNM booking overlaps with one or more shifts, another algorithm puts this demand in all the partitions with shifts it intersects with. TemporalEdgeCaseHandler will utilize such demands information to modify 1124 start and end depot of shifts, and later mark these demands as unschedulable. These demands will not go to scheduler 130. When restoring final output, some embodiments do de-duplication to restore the original booking.

### Additional Observations About Scheduling Operations Agent

Scheduling Operations Agent (SOA) is an internal prototype automated scheduling solution within the AI (artificial intelligence)/ERP (Enterprise resource planning) Frontline™ (mark of Microsoft Corporation) ecosystem that assigns tasks (work orders) to resources (people, equipment, etc.) and suggests routes for resources to navigate efficiently between their tasks. The SOA is designed to handle complex scheduling challenges in enterprise environments, ensuring both accuracy and efficiency. This scheduling agent is given as input a set of resources and their respective bookings (i.e., already-scheduled work orders) and a set of new work orders. Each work order has a set of attributes and constraints that dictate when they can be scheduled and which resources are eligible to handle them. Similarly, resources have attributes and constraints that define their availability, including work hours, scheduled breaks, and other time-related conditions. The system also is designed to account for spatial constraints, ensuring resources are routed efficiently between tasks to minimize travel time and costs. The agent's goal is to generate an efficient schedule that maximizes resource utilization, minimizes travel distance, and adheres to customer defined temporal and non-temporal constraints, all within a limited timeframe. Specifically, SOA targets producing a schedule within 10 seconds for a typical scenario involving a 5-day optimization range, 10 resources, and 1,000 work orders.

The SOA operates with feasible input schedules (i.e., meeting all required constraints) in order to guarantee feasible output schedules. If the agent operated entirely autonomously with no human intervention, then it would be relatively easy to validate that the schedules it produces meet all customer-defined attributes at all times. However, the scheduling process is often highly dynamic, and in some scenarios, customers can collaborate with the agent by interacting with their schedules both manually and through plug-ins. This flexibility, while valuable, can introduce inconsistencies 1122 that the SOA is to account for to ensure effective scheduling outcomes.

For instance, customers in some scenarios inadvertently assign workers who do not meet the skillset or other required attributes specified by the work order. Alternatively, customers in some scenarios deliberately assign work to resources that violate their own defined resource preference in order to prioritize urgent work or manage unforeseen circumstances. In such cases, although the schedule sometimes becomes technically infeasible by SOA's internal standards, the modified plan sometimes aligns better with the customer's immediate operational goals. Another common source of inconsistency arises from travel estimation data. For example, customers sometimes observe that the travel estimates provided by services are inaccurate due to unexpected traffic conditions or road closures. Consequently, they sometimes override the predicted travel spacing to fit tasks closer together than the algorithm considers feasible. While such changes sometimes succeed in maximizing resource productivity, they risk creating a schedule that deviates from expected travel timelines and sometimes requires additional adjustments later.

The interplay between customer interventions and the automated agent presents a technical challenge: SOA attempts to balance respecting customer changes against still ensuring the final schedule is feasible. Consequently, robust inconsistency detection 1104 and conflict resolution (e.g., 1116, 1120, 914, 1312) mechanisms are beneficial to maintaining system reliability.

Some embodiments generate an Eligibility Graph for efficiently representing the attribute matching between resources and tasks, and to manage the inconsistent matching rules between bookings that cannot be reassigned to different (matching) resources. This graph structure effectively encodes constraints, reducing the need for costly recomputation from following optimization algorithms.

Some embodiments employ Problem Partitioning strategies to break down large-scale problems into manageable subproblems, removing 806 tasks that are infeasible for resources to travel to during their working hours. This method effectively enables parallel processing, and reduces computational complexity by limiting the scope of each subproblem.

Some embodiments employ Temporal Adaptation for detecting and managing temporal inconsistencies such as tasks that overlap with each other on a resource's schedule or that have infeasible travel time between them. By fixing the temporal infeasibility on the original customer-initiated schedule, some embodiments help ensure the feasibility of the optimization request and minimize interruptions to agent work.

In a scheduling model of some embodiments, resources can have skills (e.g., roof cleaning, pest control) and categories (e.g., electrician, plumber), territory 320 (e.g., Redmond, Vancouver), and resource type (e.g., user or facility). Each resource has defined working hours (e.g., 8 AM-5 PM), and is defined as either willing to travel to work locations or not. Additionally, resources sometimes have breaks that need to be accommodated within their schedules for lunch or other reasons. Similarly, each work order or task is located or is location agnostic (e.g., completable anywhere), and sometimes have time windows when the work can be done (e.g., 9 AM-12 PM), integer priority between 0-100, and required skills, categories, territory, and resource type, and sometimes restrict assignments to certain resources. Finally, in some scheduling scenarios, some resources already have work orders (i.e., bookings) assigned to them at specific times, and when a customer requires that a booking remain unchanged, an embodiment classifies it as a DoNotMove booking. These attributes and constraints for both resources and work orders are optional for customers to define, but when defined they dictate how the scheduling algorithm can assign work to resources.

There are at least two different types of inconsistencies 1122 to handle with respect to bookings on resources' schedules, each with distinct challenges. First, inconsistencies in attribute matching are issues relating to the assignment of resources to work. There are strict rules for matching based on many different resource and work attributes, and handling these inconsistencies mainly involves relaxation of the rules for each particular resource-work instance. Various types of attribute related conflicts are identified, and some embodiments resolve the inconsistencies with Attribute Matching with Eligibility Graph. Second, there are inconsistencies between temporal rules that describe the relationships between work on a resource's schedule. These inconsistencies are harder to handle because they involve changing these relationships in a way that does not violate the schedule timing for the customer. Some embodiments employ Additional Matching and Clustering for Problem Partitioning and Temporal Adaptation for Repairing Infeasible Schedules to help handle recognized temporal rule violations. The output after these steps is a feasible schedule that an automated scheduler can input in order to produce a better output schedule-more tasks on the schedule, of higher objective value, and without any unnecessary violations.

As to Attribute Matching with Eligibility Graph, in some situations the set of attributes that customers can define is complex, and reasoning about this complex set every time the scheduling algorithm checks whether a resource is capable of performing a work order is computationally expensive. For example, one algorithm checks whether all unscheduled work orders (up to 1000) would fit with a single resource's working hours (i.e., a shift) every iteration for up to 1000 iterations. To improve speed as well as to encapsulate all of the attribute matching in a single project, one prototype implements an Eligibility Graph 1106 that flattens the constraint checks, allowing a scheduling algorithm to look up valid resources for a work order or vice versa rather than iterating through all attributes all the time.

One Eligibility Graph (example shown in FIG. 22) is a bipartite graph in which one set of nodes includes all shifts of all possible resources and the other set of nodes lists all work orders. An edge connecting a shift to a work item indicates that the attributes match and the resource that owns that shift can perform that work. A shift is defined as a time segment mapped from the intersection of the optimization range and a resource's working hours. For example, if the optimization range is from 3/14 12:00 PM to 3/16 12:00 PM, and the resource's working hours are from 9:00 AM to 5:00 PM each day, the resource will have three shifts within this range: 3/14 12:00 PM to 5:00 PM, 3/15 9:00 AM to 5:00 PM, and 3/16 9:00 AM to 12:00 PM. Note that the resource could start and end at different locations during these shifts. For instance, on 3/14 and 3/16, the resource could start and end at the Seattle office, while on 3/15, they may be at the Redmond office.

In the FIG. 22 example Eligibility Graph, solid lines represent eligible matchings between shifts and work orders, while dashed lines indicate possible but ineligible edges that do not satisfy the required constraints, e.g., due to mismatch in one or more of a Territory, Resource Preference, Resource Type, Category, or Skill. The resulting partitions 2202 derived from the Eligibility Graph are indicated by rounded-corner rectangles in FIG. 22. These partitions are completely disconnected from each other, meaning no eligible edges exist between separate partitions.

One reason to use shifts as a representation instead of resources is that some attributes are time-based (e.g., technician role only valid until 12/31/2025 before license expire), and shifts represent one unit of time for the resource. Another reason is that owning multiple shifts means the resource has the flexibility to work on different territories on different days of the week. By leveraging the Eligibility Graph, the scheduling algorithm can efficiently retrieve all eligible shifts for a work order, or all work orders for a shift, without querying individual constraints at runtime. The computational complexity of constructing the Eligibility Graph is O(s*w*c), where s is the number of shifts, w is the number of work orders, and c is the number of constraints.

Inconsistencies handled by the Eligibility Graph include those in which a resource does not match the attributes required by the booked work order, and they are resolved by either removing the booking if possible or otherwise bending the attribute matching rules (i.e., for DoNotMove bookings). Any booking that is not DoNotMove with mismatched attributes will benefit from an Eligibility Graph algorithm; the booking will not have edges between ineligible shifts in the graph, which implies that a scheduling algorithm will not try to reschedule it back in that shift. In contrast, some embodiments help ensure that a DoNotMove booking remains eligible only for its originally assigned shift, ignoring all other matching rules, so that the scheduling algorithm will operate with a determination that the booking is in a valid shift and not move it to a different shift.

As to Additional Matching and Clustering for Problem Partitioning, in addition to attribute matching, there are other ways that some embodiments determine a work order is ineligible to be performed in a shift. For example, a location-based clustering approach 1110 is sometimes used to determine whether a resource has enough time in their shift to travel to and from each work order. Any work order where there is not enough time for a resource to start their shift, travel there, and return is ineligible, though other less rigorous rules are applied in variations, such as clustering to assign only nearby resources (that also match other attributes). As another example, work orders sometimes have promise windows 468 designating the hours they could be accomplished, consistent in some with a filter 470; resources with shifts strictly outside of these ranges are marked in some variations as ineligible and others clustered based on percentage overlap.

Some embodiments incorporate this information into either the Eligibility Graph or another approach. One advantage and compatibility of clustering-based approaches and the Eligibility Graph is their ability to partition the original large scheduling problem into disjoint subproblems, enabling 1330 parallel execution 1332 for better performance. The Eligibility Graph-based partitioning has the benefit that it only creates a subproblem for data that is truly disjoint, while clustering-based approaches depend on statistical modeling to divide the space.

To improve 1330 scalability 1332 of scheduling algorithms as a whole, some embodiments decompose the original scheduling problem into disjoint subproblems by partitioning the Eligibility Graph into separate, disjoint subgraphs. This separation is performed quickly through graph traversal, visiting each node exactly once. Each subgraph represents a smaller, self-contained scheduling problem that is independently solvable, as there are no eligible edges that connect the two subproblems. Shifts and work orders with edges connecting them form a single partition. As shown in the FIG. 22 example Eligibility Graph, Shift 1, Shift 2, DoNotMove work order, and Work Order 1 are interconnected, forming a larger partition, while Shift 3 and Work Order 2 create a smaller one. In the figures, Shift 1 is also shown as Shift1 [no space], etc., while Shift-1 or S-1 indicates Shift with a subscript 1. More generally, some partitions contain only shifts or only work orders; in such cases, one scheduling algorithm skips those partitions. While it is possible to include some of the location-based attribute matching into the Eligibility Graph when a work order is completely ineligible for a shift, it is not guaranteed that this is enough to produce small subproblems and the clustering methods are often still beneficial.

As to Temporal Adaptation for Repairing Infeasible Schedules, some embodiments include a dedicated component to handle temporal conflicts of DoNotMove bookings. Recall that DoNotMove bookings are those that cannot be rescheduled despite possible inconsistencies in the customer data. In addition, a SOA prototype supports both on-site and location agnostic resources/jobs. All combinations of DoNotMove bookings and resources are considered in some embodiments. After analysis, there are multiple scenarios where the DoNotMove bookings set by customers are invalid, which can be categorized into these groups: (1) bookings overlap with each other, (2) not enough travel time between bookings or from/to resource start or end location, (3) bookings partially or completely outside resource working hours. Directly passing these bookings to the scheduler 130 risks causing the algorithm to fail, as those bookings do not represent a feasible schedule.

In some embodiments, a Temporal Adaptation component 1906 processes such bookings before the scheduling algorithm, performing two steps: Repairing Bookings 1312 and Repairing 1312 Shifts. First, to repair the bookings, the embodiment finds bookings that either (1) have durations that overlap each other, or (2) do not have enough travel time between them. Such bookings are put into a group. The group represents a continuous span of time that a scheduling algorithm could not derive a valid schedule, and the algorithm should not assign other jobs to this time span. A new “virtual” booking 1118 is created to represent the entire booking group time span. The single booking is now consistent, and the original (invalid) bookings are removed from the scheduling problem temporarily.

This virtual booking is like normal bookings, except it sometimes has different start and end locations, as it actually encompasses several bookings. An embodiment properly sets 1124 the start and end location to calculate travel time from/to this virtual booking (equivalent to calculate travel time from/to the set of DoNotMove bookings it represents). This new booking now is unique because it potentially represents a series of work order bookings that occur in different locations. Resource start/end locations are also considered in this process, to better reflect the actual location of the resource. The start/end location is set to the earliest/latest known on-site location in the time span of the virtual booking. With this transformation, a scheduling algorithm 130 is able to schedule the virtual bookings the same way as other bookings (at least, from the scheduler's perspective).

These virtual bookings, together with other standalone DoNotMove bookings, are compared to all resource work hours (shifts). Bookings that are partially or completely outside working hours are marked 1326 as unschedulable and removed from the scheduling problem and Eligibility Graph, but saved for later so they will be returned as unchanged to the customer. Furthermore, if these bookings intersect with shift boundary, the shift is truncated with location adjusted, so that the unschedulable booking is no longer in the updated shift. If a shift is completely covered by some DoNotMove bookings, the shift is removed from scheduling problem.

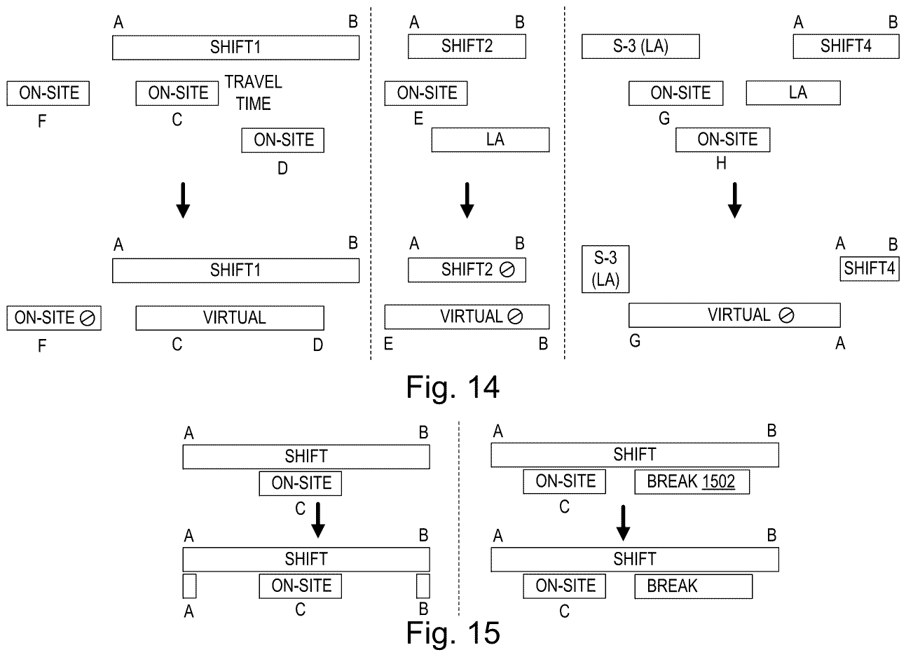

An example of the Temporal Adaptation output is shown in FIG. 14. The jobs (ON-SITE boxes) are all Do Not Move bookings. Overlapping bookings, and bookings without enough travel time are transformed into virtual bookings (VIRTUAL boxes). Bookings are outside shift working hours are marked as unschedulable. Shifts can be unchanged (shift 1), removed from problem (shift 2), or truncated (shift 3 and 4).

There are four shifts and eight DoNotMove bookings in this example problem. The booking with location F is outside any shift range, therefore marked as unschedulable and removed from the problem. The time between the onsite booking with location C and the booking with location D is less than the required travel time, therefore these two bookings are merged into one virtual booking.

This virtual booking has start location C, and end location D. In this example, the embodiment assumes the resource needs to arrive at location C at the beginning of the virtual booking and leaves from D at the virtual booking's end time. The virtual booking is completely within shift 1's working hours, therefore the virtual booking and shift 1 are kept as is in the problem.

Next, the onsite-booking with location E overlaps with a location agnostic booking, and they intersect with shift 2's boundary. A new virtual booking is created with start location E (as booking at location E appears before shift start location A), and end location B (as booking at location E ends before shift ends). Shift 2 is completely covered by the new virtual booking, therefore both the shift and virtual booking got removed from the problem (no more bookings can be assigned to this shift).

Third, three overlapping bookings are merged into a virtual booking. Shift 3 is location agnostic (LA), therefore the virtual booking has start location being G (the earliest onsite location). The last on-site booking ends before shift 4 starts, therefore the virtual booking's end location set to the shift 4's start location A. Shift 3 and shift 4 are truncated so that they don't overlap with the virtual booking. After adjustment, the virtual booking is completely outside shift range, therefore it will be marked as unschedulable, and not considered in scheduling algorithms.

By taking these steps, the scheduling problem will not have temporally invalid inconsistent bookings, ensuring feasibility of the problem, and allowing the scheduling algorithm to run unimpeded. The overall count of bookings and shifts is also reduced sometimes by such repairs, saving scheduler running time.

Internal experiments determined that some prototypes dynamically adapted to data inconsistencies in every customer-triggered optimization request. Experiments also validated scalability using synthetic data, demonstrating an ability to handle growing problem sizes with minimal preprocessing overhead.

Experiments employed a dataset similar to the target limit for SOA, processing 50 shifts, 10 resources, and 1,300 work orders. The total preprocessing time was only 0.087 seconds, consuming just 0.87% of the overall 10-second scheduling time budget. To explore scalability, experiments included:

increasing the number of work orders (row 2), shifts (row 3), or both simultaneously (row 4). The results showed that tripling the number of work orders led to a sixfold increase in processing time, likely due to the need to evaluate additional eligibility constraints. In contrast, tripling the number of shifts resulted in only a 2.5× increase in processing time. This smaller impact can be attributed to the fact that shifts coming with predefined features (e.g., skill sets) do not necessarily require additional compatibility checks with work orders. However, when new work orders are introduced, they would impose additional feature checks on shifts. When both factors were increased—tripling the number of work orders and adding three times more shifts—the processing time grew 14 times. This observation aligns with the O(s*w*c) computational complexity. The results demonstrate that the components introduced in this disclosure efficiently scale without significantly impacting overall runtime, confirming their effectiveness in supporting larger problem instances.

With respect to Responsible AI considerations, beneficial algorithms described herein operate without the need for training on datasets. Additionally, experimentation took strict measures to ensure data privacy and security. No customer identifiable information was logged in telemetry, and all statistical analyses were derived solely from aggregated data.

This disclosure introduces scalable techniques to enhance enterprise resource scheduling, focusing on computational efficiency and adaptability. Some embodiments leverage Eligibility Graphs for rapid constraint handling, Problem Partitioning for parallel execution, and Edge Case Handling to address real-world data inconsistencies. These techniques enable high-performance scheduling, making them suitable for large-scale industrial applications. Beyond resource scheduling, the techniques presented in this disclosure have broader applicability in practical applications across domains such as warehouse optimization and supply chain optimization. By extending embodiments of these methods to other logistics-driven problems, enterprises can achieve greater efficiency, scalability, and resilience in their operations.

Some embodiments build on the insights gained from Eligibility Graphs and Edge Case Handling by utilizing logged information from detected ineligible cases and infeasible edge scenarios. Some embodiments enhance both the user experience and the overall effectiveness of SOA or other implementations, ensuring that customers can proactively manage their data quality and gain better insights into scheduling decisions.

First, some embodiments include a proactive detection mechanism that identifies 1104 infeasible data entries at the point of customer input. By warning customers during data entry, some embodiments highlight the potential issues and their impact before they reach the scheduling stage. This empowers 1330 a scheduling algorithm to address problems early 1332, improving scheduling outcomes and reducing errors.

Second, to assist customers in improving their data quality, some embodiments generate 1330 summaries of the most frequent infeasibility patterns detected. These summaries offer actionable insights 1332, allowing customers to prioritize addressing the most impactful issues.

Third, some embodiments provide an interactive language model feature that assists 1330 customers in understanding scheduling decisions, e.g., by enabling customers to inquire about specific optimization results. Leveraging logged data, this tool explains 1332 the reasoning behind scheduling decisions and highlights conflict constraints or data issues that influenced the outcome. As illustrated in a chat dialog below, this feature enhances customer understanding of optimization results.

User Account: Why are there overlapped bookings on my schedule?

Tool: Can you please provide the resource id or booking id? User Account: On-site C and D.

Tool: On-site C and D are both classified as DoNotMove bookings.

They were originally scheduled at overlapping times. Because they're designated as DoNotMove, they can't be rescheduled or moved to a different time, which is why they appear overlapped on your schedule.

### Additional Observations About Edge Case Handling

This edge case handling 1906 is not addressed to broken data such as Invalid Latitude/Longitude or Duplicate Job Ids. Rather, it addresses valid customer inputs leading to an infeasible schedule. In some embodiments, the scheduler attempts to create a schedule that maximizes objectives (e.g. utilization) while satisfying all enabled constraints (e.g. a locked booking cannot be moved). The user can configure their schedule request such that it is impossible to satisfy all constraints (e.g. there are overlapping locked bookings).

In these embodiments, the Agent (SRO or another implementation) does not simply reject the request. Instead, it keeps running and attempts to work around the problem posed by the inconsistent customer-provided scheduling request data.

Some conflicts 1122 are Requirement vs Booking conflicts, e.g., involving Location, Duration. Some conflicts are Booking conflicts, e.g., in which: A resource is in both MustChooseFrom and RestrictedFrom; A locked resource is in RestrictedFrom; A MustChooseFrom resource doesn't have required data (Category, Territory, ResourceType, or Characteristics); A locked resource doesn't have required data (Category, Territory, ResourceType, or Characteristics); An onsite booking is locked to a location agnostic shift; or A locked to time booking is outside promise time windows. Some conflicts are DoNotMove Booking conflicts, e.g., in which there is: Not enough time between two DoNotMove bookings; Not enough time from shift start location to DoNotMovebooking; or Not enough time from DoNotMovebooking back to shift end location. Some conflicts involve Overlapping Shifts or Overlapping Breaks.

Some embodiments model Shifts and Breaks as illustrated by FIG. 15. Per the left side of FIG. 15, some embodiments enforce a requirement for the resource to be at the shift start/end location (“depot”). The depot requirement is of 0 duration with the location being the shift depot location. It is marked as mandatory. Per the right side of FIG. 15, in some embodiments a Break is functionally equivalent to a mandatory location-agnostic (LA) requirement.

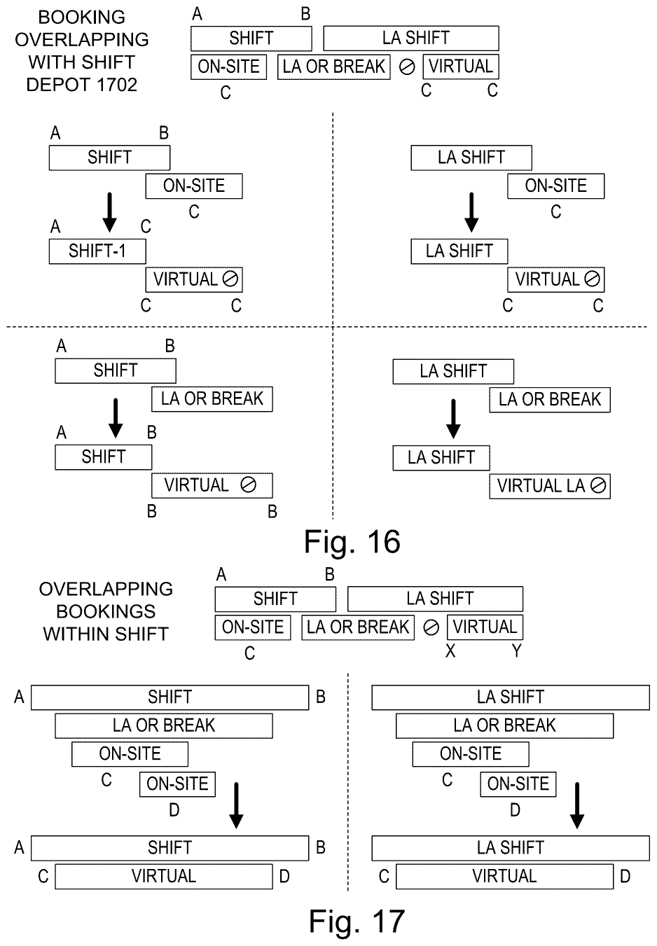

Some conflicts involve Booking Overlapping with Shift Depot, as illustrated in FIG. 16. As to the top two portions of FIG. 16, some embodiments mark DNM on-site booking as a DNM virtual on-site booking, set virtual booking locations to original booking location, shrink shift to not overlap with virtual Booking, set virtual shift end depot location to virtual booking location, and mark virtual booking as ineligible for any shift. As to the bottom left portion of FIG. 16, some embodiments mark DNM LA booking/break as a DNM virtual on-site booking with location matching the shift end depot, and shrink shift to not overlap with virtual booking. Depots are unchanged. Mark virtual booking as ineligible for any shift. As to the bottom right portion of FIG. 16, some embodiments mark DNM LA booking/break as a DNM virtual LA booking, shrink shift to not overlap with virtual booking, and mark virtual booking as ineligible for any shift.

Some conflicts involve Overlapping Bookings within Shift, as illustrated in FIG. 17. As to both portions of FIG. 17, some embodiments create a virtual booking encapsulating overlapping DNM bookings. Virtual booking start/end locations will be earliest/latest on-site locations. If all overlapping bookings are LA, virtual booking will be LA. Mark virtual booking as DNM and only eligible for this shift. As to the right portion of FIG. 17, if virtual booking is LA, mark as DNM and only eligible for this shift.

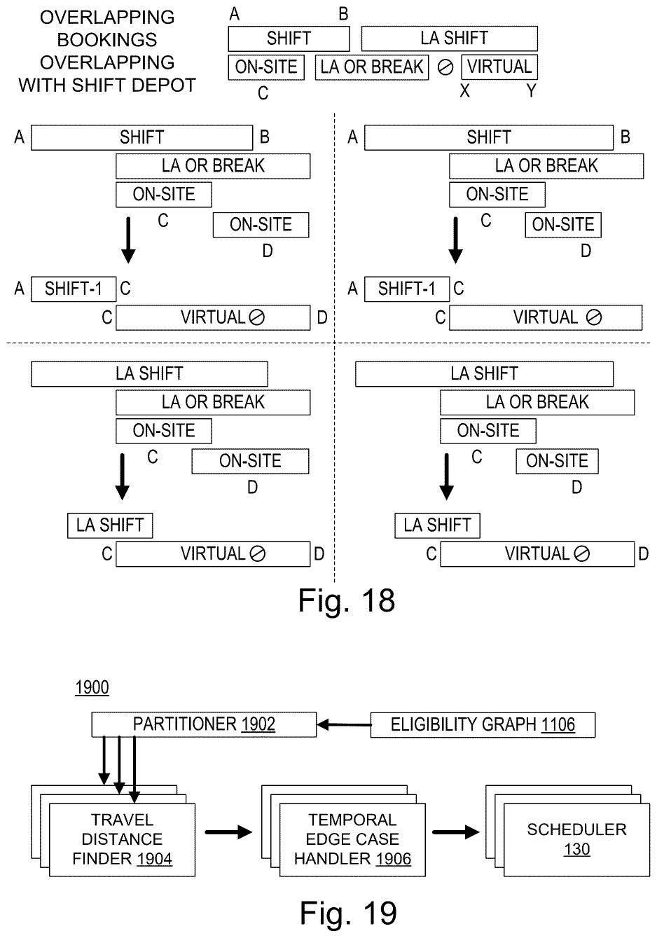

Some conflicts involve Overlapping bookings overlapping with shift depot, as illustrated in FIG. 18. As to all portions of FIG. 18, some embodiments group overlapping bookings into virtual booking, set the virtual booking start/end locations to the earliest/latest locations of the constituent bookings and depots that fall within the virtual booking time, shrink shift and set depot locations to the virtual booking location, and mark virtual booking as DNM and ineligible for any shift. As to the top right portion, a difference is that the end location of the virtual demand is the end depot location since that is the latest location the resource must be at within the overlapping time period. As to the two bottom portions, if virtual booking is LA, mark as DNM and ineligible for any shift.

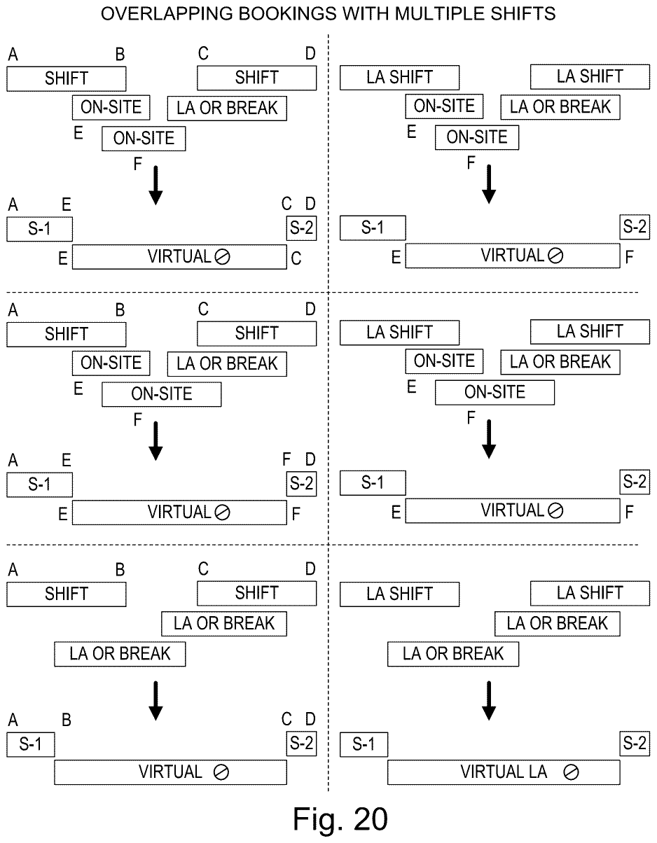

Some conflicts involve Overlapping bookings with multiple shifts, as illustrated in FIG. 20. As to the leftmost portions of FIG. 20, some embodiments group overlapping bookings into virtual booking, set the virtual booking start/end locations to the earliest/latest locations of the constituent bookings and depots that fall within the virtual booking time, shrink shifts and set depot locations to the virtual booking location, and mark virtual booking as DNM and ineligible for any shift. As to the center left portion of FIG. 20, a difference is that the end location of the virtual demand is actually the last on-site booking location since that is the latest location the resource must be at within the overlapping time period. As to the bottom left portion of FIG. 20, since the embodiment marks the virtual booking as ineligible for all, it is free to ignore how the resource gets from B->C. As to the rightmost portions of FIG. 20, some embodiments group overlapping bookings into virtual booking, set the virtual booking start/end locations to the earliest/latest locations of the constituent bookings and depots that fall within the virtual booking time, shrink shifts and set depot locations to the virtual booking location, and mark virtual booking as DNM and ineligible for any shift.

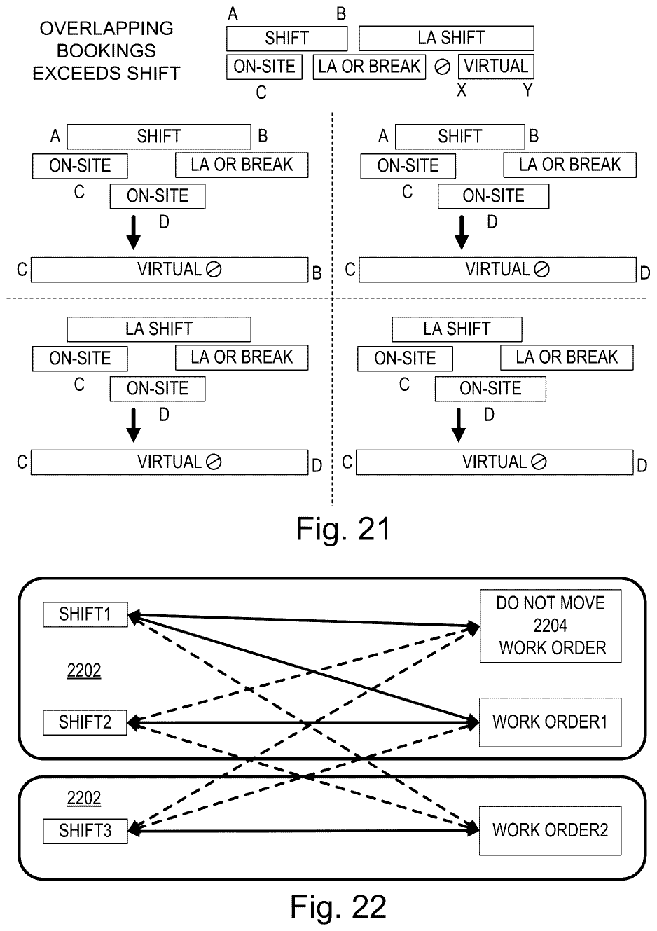

Some conflicts involve Overlapping bookings exceeds shift, as illustrated in FIG. 21. As to all portions of FIG. 21, some embodiments group overlapping bookings into virtual booking, set the virtual booking start/end locations to the earliest/latest locations of the constituent bookings and depots that fall within the virtual booking time. If virtual booking encapsulates the entire shift, delete the shift. Mark virtual booking as DNM and ineligible for any shift. Remove the deleted shift from eligibility graph. As to the bottom left portion, a difference is that the end location of the virtual booking is D instead of B.

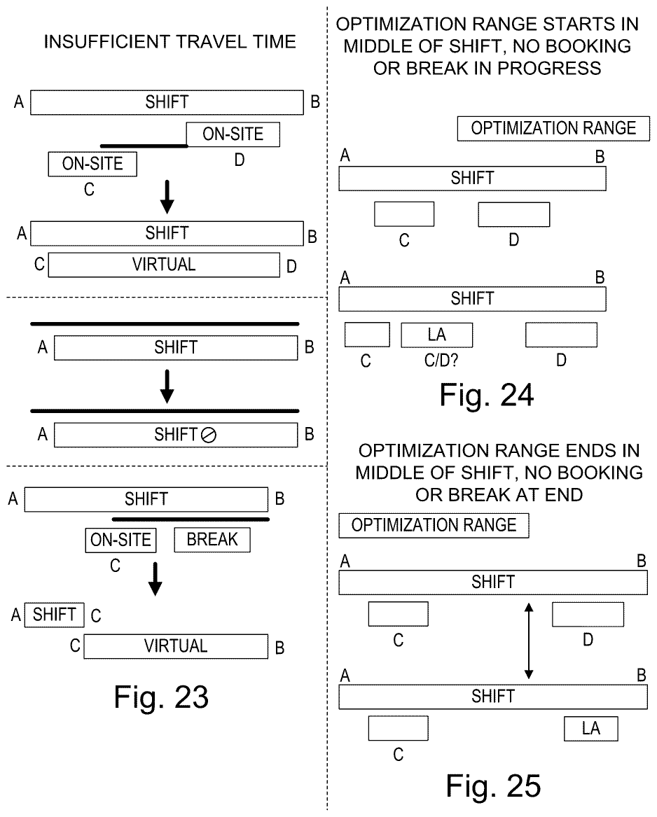

Some conflicts involve Insufficient travel time, as illustrated in FIG. 23. As to the top portion of FIG. 23, some embodiments treat this the same as overlapping bookings described in previous cases. As to the center portion, mark shift as ineligible. As to the bottom portion, group all bookings between the on-site DNM booking and depot into a virtual booking.

Some conflicts involve optimization range starts in middle of shift with no booking or break in progress, as illustrated in FIG. 24.

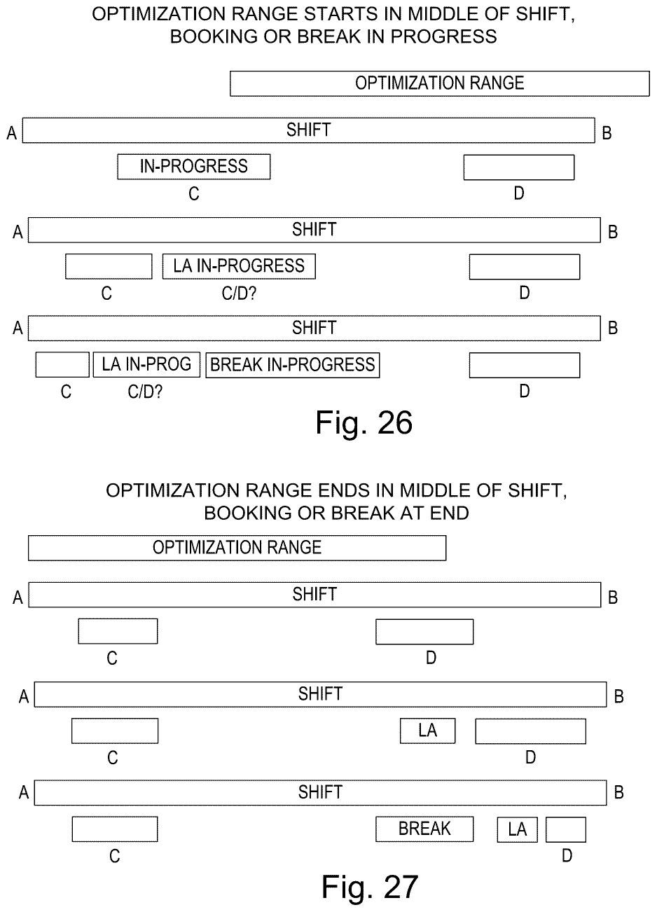

Some conflicts involve optimization range starts in middle of shift with booking or break in progress, as illustrated in FIG. 26.

Some conflicts involve optimization range ends in middle of shift with no booking or break at end, as illustrated in FIG. 25.

Some conflicts involve optimization range ends in middle of shift with booking or break at end, as illustrated in FIG. 27.

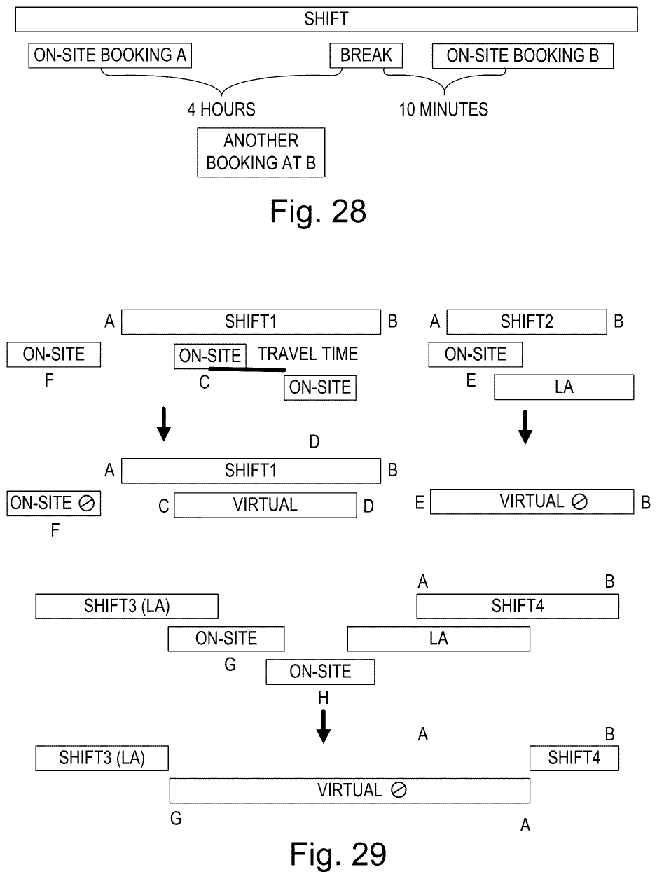

Some conflicts involve too many locked bookings, or not enough travel time for DoNotMove bookings. In the example shown in FIG. 28, travel time is 30 minutes between A to B, and a Schedule Board doesn't allow split travel and Booking.

When not suitably handled, these and similar temporal edge cases lead to algorithm complications (in implementation, testing complexity, debugging), poor explainability of scheduling results, and customer incident reports. It is beneficial to detect them as early in the user input processing as possible, and take action such as blocking them from a scheduling request, warning the customer of their inconsistency, or both.

Some approaches invalidate an entire shift if an infeasibility is detected, which is simple to implement in that a single reconciliation applies to most edge cases, is predictable, and is easy to explain. However, this increases the blast radius of a local problem, and is unacceptable in some scenarios.

Some embodiments assign priority to edge cases, determining which ones to resolve first and which to defer. For example, some embodiments give higher priority to conflicts that involve DNM bookings than to other conflicts. FIGS. 16, 17, 18, 20, 21, 23, and 29 also represent test results, illustrating uses of virtual bookings as taught herein.

Some embodiments use a Simple Temporal Network to calculate the time line during scheduling.

### Nuggets

The “nuggets” discussed below provide yet another perspective on aspects of functionality 204. A given embodiment includes data structures, executable instructions, and/or other functionality corresponding to none, one, or more of these nuggets, or to portions of zero, one, or more nuggets.

Nugget #1. Detect an infeasibility that does not depend on distance info, so it can be detected even before the Partitioner step in the Location-based partitioning document's flow chart. In some embodiments, this is part of a proactive detection mechanism that identifies one or more infeasible data entries at the point of customer input. These infeasibilities include one or more of: (A) Worker in two overlapping DNMs at two locations, (B) Booking Conflicts, (C) Conflicts involving overlapping shifts, or overlapping breaks, (D) Booking overlapping with shift depot, (E) Overlapping bookings within shift, (F) Overlapping bookings overlapping with shift depot, (G) Overlapping bookings with multiple shifts, (H) Overlapping bookings exceeds shift.

In some scenarios, DNM doesn't have to have a location. Located or location-agnostic, no matter what DNM bookings cannot overlap. Also, a DNM booking could overlap with shift or break.

In some embodiments, detecting and handling one or more of the following infeasible cases are done in Eligibility Graph functionality: a resource is in both MustChooseFrom and RestrictedFrom; a locked resource is in RestrictedFrom; a MustChooseFrom resource doesn't have required data (Category, Territory, ResourceType, or Characteristics); a locked resource doesn't have required data (Category, Territory, ResourceType, or Characteristics); an onsite booking is locked to a location agnostic shift; or a locked to time booking is outside promise time windows. All other overlapping or transit issues are handled in these embodiments by Temporal Edge Case Handler functionality.

Nugget #2. Phase 2 (steps a through g) of the algorithm flow in the Location-based partitioning algorithm, plus Phase 3. This algorithm is invoked in some embodiments when subproblems are still too big, as determined, e.g., by projected use amount of computational resources, or by predetermined thresholds on the number of unscheduled work orders, shifts, or transit cost matrix size. In some embodiments, this algorithm utilizes geo information for further partitioning, while continuing to consider eligibility at the same time.

Nugget #3. In the Location-based partitioning algorithm, if a DNM booking does not overlap with any shift, then put it in any partition with a shift from the resource it is assigned to. TemporalEdgeCaseHandler will later correctly mark it as unschedulable.

Nugget #4. In the Location-based partitioning algorithm, if a DNM booking overlaps with one or more shifts, put this demand in all the partitions with shifts it intersects with. TemporalEdgeCaseHandler will use such demands information to modify start and end depot of shifts, and later mark these demands as unschedulable. These demands will not go to the scheduler anyway. When restoring final output, some embodiments do de-duplication to restore the original booking.

Nugget #5. Detect an infeasibility which does depend on distance, such as: (A) DNM bookings with not enough time, or (B) Insufficient travel time. Nugget #6. Virtual booking scenarios identified herein.

Nugget #7. To repair the bookings, find bookings that either (1) have durations that overlap each other, or (2) do not have enough travel time between them. Such bookings are put into a group data structure. The group represents a continuous span of time that a scheduling algorithm could not derive a valid schedule, and the algorithm should not assign other jobs to this time span. A new virtual booking data structure is created to represent the entire booking group time span.

Nugget #8. Set the start and end location to calculate travel time from/to this virtual booking (equivalent in some embodiments to calculating travel time from/to the set of DoNotMove bookings it represents).

Nugget #9. In some embodiments, these virtual bookings, together with other standalone DoNotMove bookings, are compared to all resource work hours (shifts). Bookings that are partially or completely outside working hours are marked as unschedulable and removed from the scheduling problem and Eligibility Graph, but they are saved for later so they will be returned as unchanged to the customer.

Nugget #10. If a booking intersects with a shift boundary, the shift is truncated with location adjusted, so that the unschedulable booking is no longer in the updated shift.

Nugget #11. If a shift is completely covered by some DoNotMove bookings, the shift is removed from scheduling problem.

Nugget #12. In some embodiments, the system unpacks 1120 virtual bookings from the schedule, and then provides the schedule as a partial solution. It's partial because, e.g., conflicting DNMs will still be part of the schedule. The conflicted DNM and other scheduled bookings are returned together back to customers as a scheduling solution.

Nugget #13. Some embodiments generate summaries of the most frequent infeasibility patterns detected. These summaries offer actionable insights, allowing customers to prioritize addressing the most impactful issues.

Nugget #14. An interactive language model feature enables customers to inquire about specific optimization results. Leveraging logged data, this tool explains the reasoning behind scheduling decisions and highlights conflict constraints or data issues that influenced the outcome.

Nugget #15. Implementation using chunking and Retrieval Augmented Generation in the interactive language model feature to discuss/explain scheduling that involves inconsistent customer data.

Nugget #16. Implementation using LLM function calls in the interactive language model feature to discuss/explain scheduling that involves inconsistent customer data.

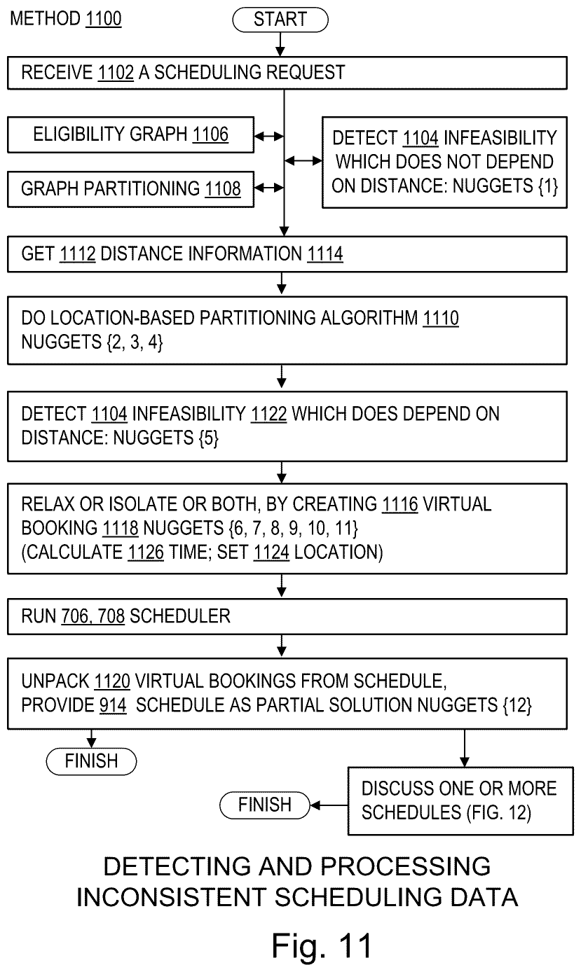

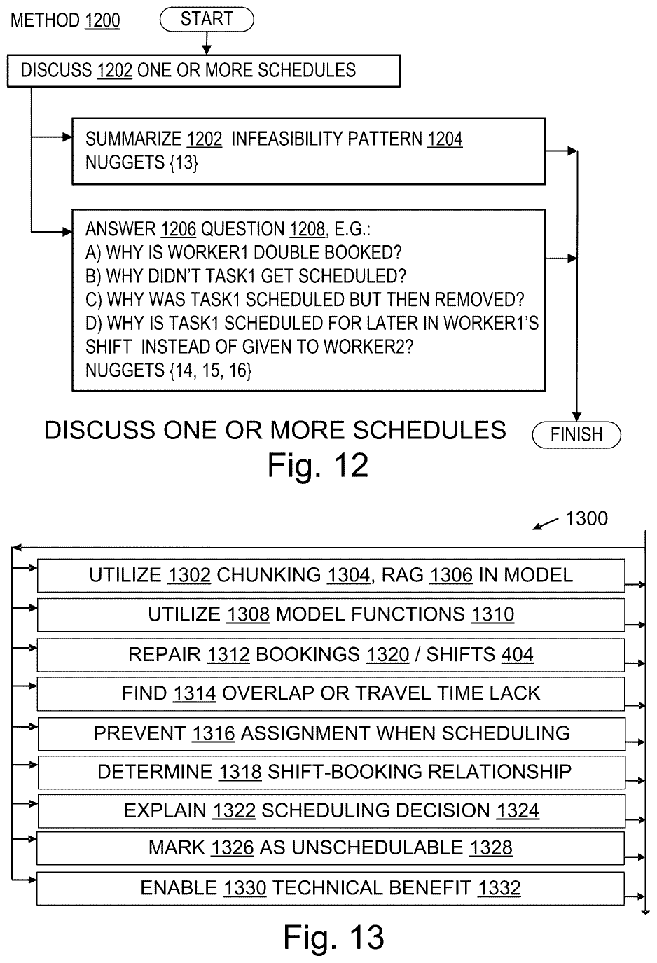

Nugget #17. Any portion of either or both of the FIG. 11 or FIG. 12 flowcharts which includes DPISD functionality.

### Additional Observations About Schedule Discussion Functionality

Some embodiments include an interactive language model feature that assists customers in understanding scheduling decisions. As to using a large language model (LLM) or other language model for explainability, some embodiments perform according to the data flow in FIG. 11. The language model was given context via prompt input, as indicated in FIG. 12. Some embodiments include non-exclusive architectural options: retrieval augmented generation (RAG) supported by chunking, and functions.

Some embodiments summarize infeasibility patterns, e.g., double books or other conflicts identified herein, according to frequency order. A user interface in some embodiments provides functionality to dive into a given pattern for more details, e.g., within a category which is labeled or tagged, and eventually displays the individual infeasibility examples encountered within a schedule or a set of schedules. Some provide filters, e.g., by resource or scheduling requirement. Some embodiments process and answer 1206 queries 1208, e.g., why is this a double book, why is this job not booked, what if this data is changed, why is the schedule this way instead of that way, how can the schedule be improved to accomplish the following goal?

In some embodiments, a data flow includes a question from a user account (e.g., UI) to an assistant (LLM) which invokes functions (software code) which perform database lookup to get data, then send responses back to the assistant, which sends an answer to the user account. A single prompt to the LLM can lead to multiple function calls (function chaining). A response can be in the form of JSON payloads.

In some embodiments, a prompt gives the LLM some context, e.g., via text stating information such as: “In a schedule, resources are assigned to complete requirements at specific times. A requirement that has been scheduled is also referred to as a booking. The process of scheduling requirements and resources is called an optimization. A resource's working hours comprises of shifts. A requirement can only be scheduled during a resource's shift. A requirement can either be on-site or location-agnostic. A requirement can only be scheduled to a resource's shift if it is deemed eligible for that resource and shift. These eligibility criteria are also referred to as constraints. Below are the constraints that are enforced.—Location-Agnostic Constraint: A location agnostic shift cannot contain any on-site requirements. However, location agnostic requirements can be scheduled in on-site shifts.—Characteristics Constraint: A requirement can only be scheduled to a resource if the resource has the required characteristics. For example, a requirement that requires a specific skill can only be scheduled to a resource that has that skill.—Territory Constraint: A requirement can only be scheduled to a resource if the resource is in the same territory 320 as the requirement. For example, a requirement that is in New York can only be scheduled to a resource that is also in New York. If a requirement is not deemed ineligible for a resource's shift, that implies that it is eligible. When an optimization is run, it may contain existing bookings that were already scheduled before the optimization began. Generally speaking, the optimization is free to modify bookings and even remove them from the schedule if it deems it necessary. But sometimes a booking can be marked as DoNotMove. If this is the case, the booking cannot be moved to a different time or assigned to a different resource. It must remain unchanged over the course of the optimization. Additionally, it is possible that some of these bookings could be infeasible for any of the following reasons:—The booking overlaps with one or more other bookings and all involved bookings are marked as DoNotMove.—Part of the booking is scheduled outside of the resource's shift and the booking is marked as DoNotMove.—A booking is ineligible for the resource's shift and the booking is marked as DoNotMove. If an infeasible booking or set of bookings is encountered, the optimization will treat that booking as if it is marked as DoNotMove. The user must manually intervene to resolve the issue. A DoNotMove booking ignores all eligibility constraints. If a requirement is eligible for a resource's shift, there is a chance the optimization will schedule it in that shift. However, the optimization is free to schedule the requirement in a different eligible shift or even not schedule it at all. The same is true for bookings that are free to be modified, which means it is possible for bookings to be unscheduled entirely. The optimization will always try to generate a schedule that optimizes against the configured goal. If a requirement of booking is not scheduled to an eligible shift, it is because the scheduler has determined that it is not the best option for the schedule. This last point should be stressed if you are asked about the scheduling of a requirement that is free to move and does not violate eligibility or feasibility.”

In some embodiments, database functionality reads JSON payloads, exposes methods that functions call as needed, and is replaceable by other data sources such as a data vault or a blob.

In some embodiments, a chunking strategy helps determine embeddings the LLM will try to match the prompt to; with good chunks the LLM will base its response on highly contextualized data but with bad chunks the LLM will base its response on irrelevant data. One internal experiment gave the LLM an entire corpus and let it decide how to chunk. One internal experiment forced the LLM to treat each line as its own chunk (most granular option). With default chunking the LLM failed to find information in the corpus. Line-by-line chunking led to better results, but still responses were often not specific to the prompt. This is apparently because notifications contained too many domain-specific terms, and retrieval struggled to correlate information about an entity distributed across multiple lines (sub-optimal chunking). Functions were investigated internally to assess whether they addressed these issues.

Some embodiments or prototypes utilized 1302 data modelling: RAG. In some scenarios, notifications have a form such as: Requirement X is not location agnostic; Resource Y has shift Z at time <start time, end time>; Requirement A is not eligible for shift B due to violated constraints C, D; Requirement E, F are infeasible for shift G.

Some embodiments or prototypes utilized 1308 model functions. In some embodiments, functions connect to the database (DB) and call database methods to retrieve data for each function. One internal prototype LLM configuration provides LLM context, registers functions with the LLM, and updates an assistant loop to invoke functions as needed. Some example functions include: GET_RESOURCE_SHIFTS_TOOL, GET_ALL_RESOURCES_TOOL, GET_ALL_SHIFTS_TOOL, GET_ALL_REQUIREMENTS_TOOL, GET_REQUIREMENT_BY_ID_TOOL, GET_BOOKINGS_BEFORE_OPTIMIZATION_TOOL, GET_BOOKINGS_AFTER_OPTIMIZATION_TOOL, GET_INFEASIBILITIES_BY_SHIFT_TOOL, GET_INFEASIBILITIES_BY_REQUIREMENT_TOOL, GET_ALL_INFEASIBILITIES_TOOL, GET_INELIGIBILITIES_BY_SHIFT_TOOL, GET_INELIGIBILITIES_BY_REQUIREMENT_TOOL, GET_ALL_INELIGIBILITIES_TOOL.

Conclusions from internal experiments included the following. Retrieval augmented generation (RAG) improved performance for large datasets due to optimized search, and did not require design and implementation of specific functions. But identifying a good chunking strategy is difficult, and data model updates may necessitate updates to chunking strategy and search index. With functions, the data model is flexible and the LLM is shielded from data model changes, and predictability improved due to deterministic retrieval logic. But functions involve an extensive setup (functions, DB), and are less flexible for out-of-distribution prompts (can overfit).

Some embodiments utilize or provide a method performed by a computing system, the method including at least one of: (a) in scheduling data, identifying bookings which overlap or lack sufficient travel time; grouping the identified bookings into a virtual booking; and computing a schedule using the virtual booking; (b) in scheduling data, recognizing a conflict which involves work attributes; resolving the conflict using attribute matching and an eligibility graph; (c) in scheduling data, recognizing a scaling opportunity (partitioning) which involves temporal rules that describe relationships between work on a resource's schedule; using clustering for problem partitioning and temporal adaptation (e.g., shorten, or merge into virtual demand); (d) summarizing scheduling infeasibility patterns; or (e) in response to an infeasibility, performing constraint relax or isolation, e.g., by virtual booking around the infeasibility, or removing in between shift demands, thereby keeping the infeasibility away from the scheduler.

In some embodiments, explainability functionality checks the eligibility graph for dependencies 326 (manifested as loops) and treats any loops as an inconsistency. Some embodiments pop up a corresponding message in the user interface.

In some embodiments, a multi-resource option supports getting jobs assigned to resources based on skills of resources. In single resource scenarios, the eligibility part of matching is sometimes simpler, because those scenarios don't face the possibility of only some things matching with some others.

In some embodiments, a filter functionality supports attribute matching in queries about schedules, e.g., a request for all electrician jobs, or all jobs that will be a match between a resource and a requirement.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage-RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers. Some embodiments address technical activities such as authentication, encryption or decryption, caching, sending and receiving data over a computer network, and storing data in particular kinds of computing system memory, which are each an activity deeply rooted in computing technology. Some of the technical mechanisms discussed include, e.g., scheduling software 220, schedulers 130 such as constraint solvers 130, job filters 218, machine learning models 448, non-human resources 512 such as robots 504, drones 506, vehicles 508, and various machines 510, and interfaces 222. Some of the technical effects discussed include, e.g., improved security 628 from system 202 enforcement of security preferences 444 such as local processing for schedule updates 710, improved computational efficiency and scalability from eligibility partitioning 1108, improved computational efficiency and scalability from location-based partitioning 1110, reduced use of computational resources through earlier detection 1104 of infeasibilities and through use of virtual bookings 1118, and explanation 1200 of scheduling decisions. Thus, purely mental processes and activities limited to pen-and-paper are clearly excluded from the scope of any embodiment. Other advantages based on the technical characteristics of the teachings will also be apparent to one of skill from the description provided.

One of skill understands that examples of job scheduling as described herein include technical activity which cannot be performed mentally at all due to, e.g., API 132 usage or scheduler 130 execution, and cannot be performed manually with the speed and accuracy required in real-world computing systems. Hence, job scheduling improvements such as the various examples of functionality 204 described herein are improvements to computing technology and to the field of computational job scheduling, which overlaps the technical field of constraint solving. One of skill understands that attempting to manually consider a set 210 of jobs which is subject to combinatorial explosion during solver execution 904 would create unacceptable delays in job scheduling, and introduce unnecessary and unacceptable human errors and security risks. People manifestly lack the speed, accuracy, memory capacity, and specific processing capabilities required to perform multi-phase job scheduling as taught herein.

Different embodiments provide different technical benefits or other advantages in different circumstances, but one of skill informed by the teachings herein will acknowledge that particular technical advantages will likely follow from particular embodiment features or feature combinations, as noted at various points herein. Any generic or abstract aspects are integrated into a practical application such as business application platform tools, business empowerment tools, scheduling services, field service schedule boards, or other personnel or resource management tools.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. In particular, no claim is made to job scheduling per se, as opposed to the particular job scheduling methods, systems, data structures, and configured storage devices described and claimed in the eventual final claims based on the present disclosure.

Rather, the present disclosure is focused on providing appropriately specific embodiments whose technical effects fully or partially solve particular technical problems, such as: how to improve the efficiency of job scheduling (e.g., by partitioning 1108 or 1110 or both, by early infeasibility detection 1104 in a mechanism 1100), how to expand the set of scheduling requests which produce at least a partial schedule (e.g., by use of virtual bookings 1118), how to process inconsistent data in scheduling requests (e.g., by detection 1104 of specific infeasibilities 1122 discussed and enumerated herein), and how to facilitate user input of consistent data in scheduling requests (e.g., by summarization or explanation using a mechanism 1200), and how to solve or mitigate other technical challenges. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

### Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, language models, prompts, motivating examples, operating environments, tools, peripherals, software process flows, identifiers, repositories, data structures, data selections, naming conventions, notations, control flows, or other implementation choices described herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CLI: command line interface, command line interpreter
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
JSON: JavaScript® Object Notation (mark of Oracle America, Inc.).
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization.

A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin (x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

Herein, activity by a user refers to activity by a user device or activity by a user account or user session, or by software on behalf of a user, or by hardware on behalf of a user. Activity is represented by digital data or machine operations or both in a computing system. Activity within the scope of any claim based on the present disclosure excludes human actions per se. Software or hardware activity “on behalf of a user” accordingly refers to software or hardware activity on behalf of a user device or on behalf of a user account or a user session or on behalf of another computational mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a technical term in the computing science arts (a kind of “routine”) but it is also a patent law term of art (akin to a “method”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. JSEF or DPISD operations such as obtaining 830 a job 134, applying 702 a filter 218, receiving 708 a schedule 208, updating 710 a schedule 208, restricting 410 a job 134 to certain location(s) 304, detecting 1104 an infeasibility 1122, creating 1116 a virtual booking 1118, performing 1108 or 1110 or both a partitioning, discussing 1202 a schedule, and many other operations discussed herein (whether recited expressly in the Figures or not), are understood to be inherently digital and computational. A human mind cannot interface directly with a CPU or other processor, or with RAM or other digital storage, to read and write the necessary data to perform the JSEF or DPISD steps taught herein even in a hypothetical situation or a prototype situation, much less in an embodiment's real world large computing environment, e.g., an internet-connected environment. This would all be well understood by persons of skill in the art in view of the present disclosure. Moreover, one of skill in the art understands that the examples of functionality 204 cannot be implemented merely with conventional tools and steps, because actual implementation requires the use of teachings which were first provided in the present disclosure, e.g., teachings that support the recited technical effects.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as adhering, applying, categorizing, choosing, classifying, configuring, determining, excluding from a set, filtering, including in a set, inserting, learning, obtaining, performing, prioritizing, providing, receiving, scheduling, selecting, sorting, submitting, triggering, updating (and adheres, adhered, applies, applied, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest. Example verbs listed here may overlap in meaning or even be synonyms; separate verb names do not dictate separate functionality in every case.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### REMARKS REGARDING REFERENCE NUMERALS

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, scheduling software 220, security controls; hardware tools; computational
124 cloud, also referred to as cloud environment or cloud computing environment
126 display screens, also referred to as “displays”
128 computing hardware not otherwise associated with a reference numeral 106, 108, 110, 112, 114
132 application program interface (API), e.g., to a scheduler 130
134 job, as represented in a computing system, e.g., by a job descriptor data structure 136 or by other data 118
202 enhanced computing system, i.e., system 102 enhanced with functionality 204 as taught herein
204 job scheduling functionality (also referred to as JSEF functionality 204, or DPISD functionality 204, or functionality 204, or enhancement 204), e.g., software or specialized hardware which performs or is configured to perform steps 704, 706, 708, and 710, or steps 702, 706, and 708, or steps 1102 and 1104, or steps 1104 and 1116, or steps 1102 and 1110, or any software or hardware which performs or is configured to perform a job scheduling enhancement activity first disclosed herein, or to perform a novel method 800 first disclosed herein
220 job scheduling software, e.g., software which withholds a filtered job from submission to a scheduler and then uses a less computationally complex algorithm than the scheduler algorithm to add the withheld job to the schedule received from the scheduler, or any software configured to perform a method 800 upon execution
700 flowchart; 700 also refers to job scheduling methods that are illustrated by or consistent with the FIG. 7 flowchart or any variation of the FIG. 7 flowchart described herein; all job scheduling method steps are computational, not human activity
800 flowchart; 800 also refers to job scheduling methods that are illustrated by or consistent with the FIG. 8 flowchart, which incorporates the FIGS. 7 through 13 flowcharts, the steps implicit or express in FIGS. 1 through 29, and all other steps taught herein, or methods that are illustrated by or consistent with any variation of the FIG. 8 flowchart described herein; all job scheduling method steps are computational, not human activity, and all items computed or computationally access in those steps are digital, e.g., jobs 134 are digital representations of real-world jobs, locations 304 are digital representations of real-world locations, and so on
828 any step or item discussed in the present disclosure that has not been assigned some other reference numeral; 828 may thus be shown expressly as a reference numeral for various steps or items or both, and may be added as a reference numeral (in the current disclosure or any subsequent patent application which claims priority to the current disclosure) for various steps or items or both without thereby adding new matter

### CONCLUSION

Some embodiments (JSEF or DPISD or both) provide or utilize a job scheduling technology 204 which detects 1104 infeasible scheduling requests 1122, such as overlapping do-not-move bookings 2204 with a given resource 214 required at different locations 304, bookings 1320 with insufficient travel time 436, or other enumerated examples (e.g., in FIGS. 14-18, 20, 21, 23-29). Some embodiments utilize 1302 retrieval augmented generation 1306 or language model 448 function 1310 invocation or both to summarize 1202 infeasibility patterns 1204, or to explain 1322 scheduling decisions 1324, or to do both. Some embodiments utilize 1116, 1120 virtual bookings 1118 to produce 914 a partial schedule 208 instead of declining to produce any schedule which involves conflicts 1122. Some embodiments partition 1108, 1110 a scheduling problem into smaller problems using an eligibility graph 1106, or using clusters 1002 computed from location data 304 and shift assignment 1004 exploration 1010, or both. Other aspects of functionality 204 are also described, and present in some embodiments.

Embodiments are understood to also themselves include or benefit from tested and appropriate security controls and privacy controls such as the General Data Protection Regulation (GDPR), and to comply with all applicable laws and regulations, e.g., the European Union Artificial Intelligence Act (EU AI Act) when applicable. Use of the tools and techniques taught herein can be done together with such controls in compliance with such laws and regulations.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

1. A computing system configured for job scheduling using location-based partitioning, the computing system comprising:
a digital memory containing job data structures, each job data structure identifying at least one resource which has a capability to perform at least a portion of a corresponding job, a job duration, and a job location which either specifies a physical location of the job or specifies that the job is location-agnostic;
a processor in operable communication with the digital memory and configured by executable processor instructions;
a clustering mechanism which upon execution provides job data structure clusters computed from at least the job locations;
a shift calculation mechanism which upon execution calculates a cluster workload and a number of shifts corresponding to the cluster workload;
a shift assignment mechanism which upon execution provides an assignment that assigns a particular shift to a particular job cluster;
a cluster coverage score calculation mechanism which upon execution calculates a cluster coverage score;
a cluster coverage score optimization mechanism which upon execution optimizes at least one cluster coverage score by utilizing at least one shift assignment change; and
a job scheduling mechanism which upon execution by the computing system provides a schedule of at least a subset of the jobs, the schedule computed from at least one shift assignment or at least one shift assignment change or both.

2. The computing system of claim 1, further comprising an infeasibility detection mechanism which upon execution detects at least one of:
a worker present in two overlapping do-not-move bookings at two different job locations;
a conflict which involves overlapping shifts or overlapping breaks or both;
a booking overlapping with a shift depot;
overlapping bookings within a shift;
overlapping bookings overlapping with a shift depot;
overlapping bookings with multiple shifts; or
overlapping bookings exceed a shift.

3. The computing system of claim 1, further comprising an infeasibility detection mechanism which upon execution detects at least one of:
do-not-move bookings with insufficient time; or
insufficient travel time between do-not-move jobs.

4. The computing system of claim 1, further comprising an infeasibility summarization mechanism which upon execution generates a summary of at least one pattern of detected infeasibilities.

5. The computing system of claim 1, further comprising a virtual booking mechanism which upon execution creates at least one of:
a virtual booking which corresponds to an on-site booking which overlaps a shift boundary or a shift depot;
a virtual booking which corresponds to location-agnostic booking or a break which overlaps a shift;
a virtual booking which encapsulates overlapping do-not-move bookings; or
a virtual booking which groups overlapping bookings.

6. The computing system of claim 1, further comprising a schedule investigation mechanism which upon execution performs at least one of:
execution of an interactive language model feature which processes an inquiry about a scheduling decision, provides an explanation of a reasoning behind the scheduling decision, and highlights a conflict constraint or a data inconsistency that influenced the scheduling decision;
execution of an interactive language model feature which utilizes chunking and retrieval augmented generation and provides an explanation of a scheduling decision that involves inconsistent customer-provided data; or
execution of an interactive language model feature which utilizes language model function calls and provides an explanation of a scheduling decision that involves inconsistent customer-provided data.

7. A method performed by a computing system for job scheduling using location-based partitioning, the method comprising:
clustering job data structures into clusters computed from at least job locations of job data structures, each job data structure identifying at least one resource which has a capability to perform at least a portion of a corresponding job, a job duration, and a job location which either specifies a physical location of the job or specifies that the job is location-agnostic;
assigning a shift to a particular job cluster;
calculating a cluster coverage score;
optimizing at least one cluster coverage score by utilizing at least one shift assignment change; and
obtaining a schedule computed from at least one shift assignment or at least one shift assignment change or both.

8. The method of claim 7, further comprising repairing overlapping bookings, wherein repairing overlapping bookings comprises:
finding two bookings which have respective durations that overlap one another;
creating a virtual booking which represents a continuous span of time that includes the two bookings; and
during scheduling, preventing assignment of other jobs to the continuous span of time.

9. The method of claim 7, further comprising repairing insufficient travel time bookings, wherein repairing insufficient travel time bookings comprises:
finding two bookings which lack sufficient travel time between one another;
creating a virtual booking which represents a continuous span of time that includes the two bookings; and
during scheduling, preventing assignment of other jobs to the continuous span of time.

10. The method of claim 7, further comprising:
determining that a shift is covered by a set of one or more do-not-move bookings; and
in response to the determining, removing the shift from data selected for submission to a scheduler to obtain the schedule.

11. The method of claim 7, further comprising:
determining that a do-not-move booking fails to overlap any shift; and
in response to the determining, marking the do-not-move booking as unschedulable.

12. The method of claim 7, further comprising:
determining that a booking fails to overlap any shift;
in response to the determining, marking the booking as unschedulable; and
removing the booking from an eligibility graph.

13. The method of claim 7, further comprising:
determining that a do-not-move booking overlaps at least one shift; and
in response to the determining, copying the do-not-move booking into a partition which includes the at least one shift.

14. The method of claim 7, further comprising:
determining that a booking has an intersection with a shift boundary; and
in response to the determining, removing the intersection by truncating the shift.

15. The method of claim 7, further comprising at least one of:
obtaining the schedule as a partial solution which includes at least one conflicting do-not-move booking;
calculating a travel time to a virtual booking;
calculating a travel time from a virtual booking;
setting a start location of a virtual booking; or
setting an end location of a virtual booking.

16. A computer-readable storage device configured with data and instructions which upon execution by a processor cause a computing system to perform a job scheduling method for job scheduling using location-based partitioning, the method comprising:
clustering job data structures into clusters computed from at least job locations of job data structures, each job data structure identifying at least one resource which has a capability to perform at least a portion of a corresponding job, a job duration, and a job location;
assigning a shift to a particular job cluster;
calculating a cluster coverage score;
optimizing at least one cluster coverage score by utilizing at least one shift assignment change; and
obtaining a schedule computed from at least one shift assignment or at least one shift assignment change or both.

17. The computer-readable storage device of claim 16, the method further comprising calculating a cluster workload and a number of shifts corresponding to the cluster workload.

18. The computer-readable storage device of claim 16, the method further comprising detecting at least three of:
a worker present in two overlapping do-not-move bookings at two different job locations;
a conflict which involves overlapping shifts or overlapping breaks or both;
a booking overlapping with a shift depot;
overlapping bookings within a shift;
overlapping bookings overlapping with a shift depot;
overlapping bookings with multiple shifts;
overlapping bookings exceed a shift;
do-not-move bookings with insufficient time; or
insufficient travel time between jobs.

19. The computer-readable storage device of claim 16, the method further comprising creating at least one of:
a virtual booking which corresponds to an on-site booking which overlaps a shift;
a virtual booking which corresponds to location-agnostic booking or a break which overlaps a shift.

20. The computer-readable storage device of claim 16, the method further comprising creating at least one of:
a virtual booking which encapsulates overlapping do-not-move bookings; or
a virtual booking which groups overlapping bookings.
